(19) United States
(12) Patent Application Publication
(10) Pub. No.: US 2014/0085511 A1
(43) Pub. Date: Mar. 27, 2014

(54) IMAGE PROCESSING DEVICE, METHOD FOR PROCESSING IMAGE, AND RECORDING MEDIUM

(71) Applicant: OLYMPUS IMAGING CORP., Tokyo (JP)

(72) Inventors: Maki TOIDA, Tokyo (JP); Manabu ICHIKAWA, Tokyo (JP)

(73) Assignee: OLYMPUS IMAGING CORP., Tokyo (JP)

(21) Appl. No.: 14/024,007

(22) Filed: Sep. 11, 2013

(30) Foreign Application Priority Data
Sep. 26, 2012 (JP) 2012-213103

(51) Int. Cl. H04N 5/262

(52) U.S. Cl. CPC H04N 5/2625
USPC 348/239

(57) ABSTRACT

An image processing device lays out a plurality of images to generate image data of a combined image, and includes: a feature value calculation unit which calculates from an image configuring the combined image a feature value indicating a feature of the image; an image correction unit which corrects the image whose feature value is calculated so that the feature value calculated by the feature value calculation unit approaches a target feature value; and a combined image generation unit which generates image data of the combined image by combining image data of the plurality of images including the image corrected by the image correction unit.

### CROSS REFERENCE TO RELATED APPLICATION

This application is based upon and claims the benefit of priority from prior Japanese Patent Application No. 2012-213103, filed on Sep. 26, 2012, the entire contents of which are incorporated herein by reference.

### FIELD OF INVENTION

The present invention is related to an image processing device, a method for processing an image, and a recording medium for laying out a plurality of images obtained from plural times of shooting operations, and generating image data of combined images which configure a picture.

### BACKGROUND

Since an image shooting device such as a digital camera, a digital video camera, etc. stores or records an acquired image as digital data, the acquired image may be easily processed. One of the uses of the image shooting device having the feature above is a combined image. A combined image refers to a composite image obtained by laying out a plurality of images acquired by performing a shooting operation for plural times.

The image shooting device for acquiring a combined image is disclosed by, for example, Japanese Laid-open Patent Publication No. 2007-053616 and Japanese Patent No. 4529561.

Japanese Laid-open Patent Publication No. 2007-053616 discloses a digital camera for continuously shooting a plurality of images and listing the plurality of images. Japanese Patent No. 4529561 discloses an image shooting device for combining and recording an optimum image selected for each subject in the images of a plurality of different subjects by taking a plurality of images for each subject.

### SUMMARY

An aspect of the present application provides an image processing device which lays out a plurality of images to generate image data of a combined image, and includes: a feature value calculation unit which calculates from an image configuring the combined image a feature value indicating a feature of the image; an image correction unit which corrects the image whose feature value is calculated so that the feature value calculated by the feature value calculation unit approaches a target feature value; and a combined image generation unit which generates the image data of the combined image by combining the image data of the plurality of images including the image corrected by the image correction unit.

Another aspect of the present application provides a method for processing an image of an image processing device which lays out a plurality of images to generate image data of a combined image, and includes: calculating from an image configuring the combined image a feature value indicating a feature of the image; correcting the image whose feature value is calculated so that the calculated feature value approaches a target feature value; and generating the image data of the combined image by combining the image data of the plurality of images including the corrected image.

A further aspect of the present application provides a non-transitory storage medium which stores an image processing program for directing a computer to use a method for processing an image by laying out a plurality of images and generating image data of a combined image, and to perform the processes, including: calculating from an image configuring the combined image a feature value indicating a feature of the image; correcting the image whose feature value is calculated so that the calculated feature value approaches a target feature value; and generating the image data of the combined image by combining the image data of the plurality of images including the corrected image.

### BRIEF DESCRIPTION OF THE DRAWINGS

The present invention will be more apparent from the following detailed description when the accompanying drawings are referenced.

FIG. 1 is a block diagram of the entire configuration of mainly the electric system of a camera according to the embodiment 1 of the present invention;

FIG. 2A is a flowchart of the entire process of the camera according to the embodiment 1 of the present invention;

FIG. 2B is a flowchart of the entire process of the camera according to the embodiment 1 of the present invention, and the continuation of FIG. 2A;

FIG. 3 is a flowchart of the image processing of the camera according to the embodiment 1 of the present invention;

FIG. 4 is a flowchart of the basic image processing of the camera according to the embodiment 1 of the present invention;

FIG. 5A is a flowchart of the special image processing of the camera according to the embodiment 1 of the present invention;

FIG. 5B is a flowchart of the special image processing of the camera according to the embodiment 1 of the present invention, and the continuation of FIG. 5A;

FIG. 6 is a flowchart of the combined image generating process of the camera according to the embodiment 1 of the present invention;

FIG. 7 is a flowchart of the still image recording process of the camera according to the embodiment 1 of the present invention;

FIG. 8A is a flowchart of the combined image operating process of the camera according to the embodiment 1 of the present invention;

FIG. 8B is a flowchart of the combined image operating process of the camera according to the embodiment 1 of the present invention, and the continuation of FIG. 8A;

FIGS. 9A through 9E are explanatory views of the shooting operation of the camera according to embodiment 1 of the present invention;

FIG. 10 is an example of a gamma conversion table used in the basic image processing illustrated in FIG. 4;

FIG. 11 is a block diagram of the function of the combined image processing unit of the camera according to the embodiment 1 of the present invention;

FIGS. 12A through 12C are explanatory views of correcting an image about the brightness performed in the combined image generating process illustrated in FIG. 6;

FIGS. 13A through 13C are explanatory views of correcting an image about the color difference (Cb) performed in the combined image generating process illustrated in FIG. 6;

FIGS. 14A through 14C are explanatory views of correcting an image about the color difference (Cr) performed in the combined image generating process illustrated in FIG. 6;

FIGS. 15A through 15C are explanatory views of correcting an image about the color saturation performed in the combined image generating process illustrated in FIG. 6;

FIGS. 16A through 16C are explanatory views of correcting an image about the hue performed in the combined image generating process illustrated in FIG. 6;

FIGS. 17A and 17B are explanatory views of an example of a method for calculating a correction parameter used in the combined image generating process illustrated in FIG. 6;

FIGS. 18A and 18B are explanatory views of another example of a method for calculating a correction parameter used in the combined image generating process illustrated in FIG. 6;

FIGS. 19A and 19B are explanatory views of an example of a further method for calculating a correction parameter used in the combined image generating process illustrated in FIG. 6;

FIGS. 20A and 20B are explanatory views of an example of a further method for calculating a correction parameter used in the combined image generating process illustrated in FIG. 6;

FIGS. 21A and 21B are explanatory views of an example of a further method for calculating a correction parameter used in the combined image generating process illustrated in FIG. 6;

FIGS. 22A and 22B are explanatory views of an example of a further method for calculating a correction parameter used in the combined image generating process illustrated in FIG. 6;

FIG. 23 is an explanatory view of the configuration of the displaying/recording image storage area of the SDRAM of the camera according to the embodiment 1 of the present invention;

FIGS. 24A through 24C are explanatory views of saving frame image data by the cancelling operation and reconstructing frame image data by the reconstructing operation of the camera according to the embodiment 1 of the present invention;

FIGS. 25A through 25C are other explanatory views of saving frame image data by the cancelling operation and reconstructing frame image data by the reconstructing operation of the camera according to the embodiment 1 of the present invention;

FIG. 26 is a flowchart of the combined image generating process of the camera according to the embodiment 2 of the present invention;

FIG. 27 is a flowchart of the combined image generating process of the camera according to the embodiment 3 of the present invention;

FIG. 28A illustrates the input and output of data of various processes performed to generate combined image data by the camera according to the embodiment 3 of the present invention;

FIG. 28B illustrates the input and output of data of various processes performed to generate combined image data by the camera according to the embodiment 3 of the present invention, and the continuation of FIG. 28A;

FIG. 28C illustrates the input and output of data of various processes performed to generate combined image data by the camera according to the embodiment 3 of the present invention, and the continuation of FIG. 28B;

FIG. 29 is a flowchart of the image processing of the camera according to the embodiment 4 of the present invention;

FIG. 30 is a block diagram of the function of the basic image processing unit of the camera according to the embodiment 4 of the present invention; and

FIG. 31 is a block diagram of the function of the combined image processing unit of the camera according to the embodiment 4 of the present invention.

### DETAILED DESCRIPTION OF THE PREFERRED EMBODIMENTS

Since a combined image gives someone a realization of a three-dimensional expression, the lapse of time, the movement of a subject, etc. by combining a plurality of frame images acquired in different scenes and different viewpoint, it is also expected as means of expressing the emotion of a camera operator.

On the other hand, a plurality of images which configure a combined image (hereafter referred to as a frame image) are independent images acquired under different conditions, and are not unified normally. Therefore, a generated combined image generally gives a disorder impression when the plurality of images are simply combined. If the image shooting device can generate only a combined image which gives a disorder impression to a person who sees the combined image, then such a combined image hardly transmits the emotion of a camera operator appropriately to viewers.

Each embodiment of the present invention is described below with reference to the attached drawings. In this specification, an image may be a still image (that is, a picture) or moving pictures unless otherwise specified. A live view image refers to an image which may be acquired at any time by the live view function of a camera unlike the image acquired at an explicit shoot instruction from a user of a camera in a releasing operation etc.

### Embodiment 1

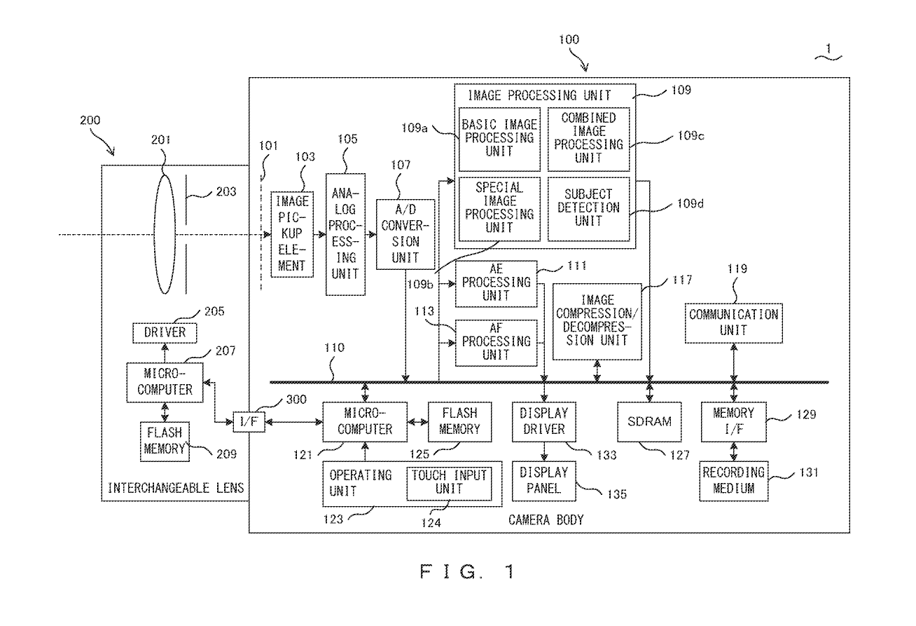

FIG. 1 is a block diagram of the entire configuration of mainly the electric system of a camera according to the embodiment 1 of the present invention;

A camera 1 exemplified in FIG. 1 is an image shooting device which stores or records an acquired image as digital data. A user of the camera 1 may issue an instruction to acquire an image by a releasing operation using an operating unit 123 while observing a live view image displayed on a display panel 135 as a display unit. The camera 1 has a function of acquiring a combined image obtained by laying out a plurality of still images or moving pictures in addition to a function of acquiring a still image (that is, a picture) and moving pictures. Then, the camera 1 is an image processing device that generating image data of a combined image from a plurality of images.

First, the configuration of the camera 1 is described with reference to FIG. 1. The camera 1 includes a camera body 100 and an interchangeable lens 200 which is detachable from and attachable to the camera body 100, and includes a taking lens 201. In the present embodiment, the configuration of a camera whose taking lens is interchangeable, but the taking lens may be fixed to the camera body.

The interchangeable lens 200 includes the taking lens 201, a stop 203, a driver 205, a microcomputer 207, and flash memory 209. The camera body 100 and the interchangeable lens 200 are connected through an interface (hereafter referred to as an I/F) 300.

The taking lens 201 is configured by one or more optical lenses for forming a subject image, and is a single focus lens or a zoom lens. Beyond the optical axis of the taking lens 201, the stop 203 is arranged. The stop 203 has a variable aperture diameter to restrict the light quantity of the luminous flux of the subject. Furthermore, the taking lens 201 may move on the direction of the optical axis by the driver 205. According to the control signal from the microcomputer 207, the focal position of the taking lens 201 is controlled. When the taking lens 201 is a zoom lens, the focal distance of the taking lens 201 is controlled. Furthermore, the driver 205 also controls the aperture diameter of the stop 203.

The microcomputer 207 connected to the driver 205 is connected to the I/F 300 and the flash memory 209. The microcomputer 207 operates according to the program stored in the flash memory 209. The microcomputer 207 which operates according to the program communicates with a microcomputer 121 in the camera body 100, and controls the interchangeable lens 200 according to the control signal from the microcomputer 121.

The flash memory 209 stores various types of information such as the optical characteristics of the interchangeable lens 200, adjustment value, etc. in addition to the above-mentioned program. The I/F 300 is an interface for communication between the microcomputer 207 in the interchangeable lens 200 and the microcomputer 121 in the camera body 100.

On the optical axis of the taking lens 201 in the camera body 100, a mechanical shutter 101 is arranged. The mechanical shutter 101 controls the irradiation time of the luminous flux of a subject to an image pickup element 103 described later by cutting off the luminous flux of a subject. For example, the well-known focal plane shutter etc. may be adopted. The image pickup element 103 is arranged at the back of the mechanical shutter 101 at the position where a subject image is formed by the taking lens 201.

In the image pickup element 103, a photodiode configuring each pixel is arranged in a two-dimensional matrix array. Each photodiode generates a photoelectric conversion current depending on the quantity of photoreception, and the photoelectric conversion current is charge-stored by the capacitor connected to each photodiode. On the front side of each pixel, an RGB filter is arranged in the Bayer layout. The configuration of the image pickup element 103 is not limited to the configuration including the RGB filter arranged in the Bayer layout. For example, a configuration of a plurality of sensors arranged in the direction of the thickness of the element such as FOVEON (registered trademark of Foveon Inc.) may be accepted.

The image pickup element 103 is connected to an analog processing unit 105. The analog processing unit 105 reads a photoelectric conversion signal (hereafter referred to as an analog image signal) from the image pickup element 103, reduces reset noise etc. and performs waveform shaping and gain-up for appropriate brightness on the signal. The analog processing unit 105 is connected to an A/D conversion unit 107. The A/D conversion unit 107 A/D converts the analog image signal, outputs an acquired digital image signal (hereafter referred to as image data) to a bus 110, and stores the signal in SDRAM 127. That is, in the camera 1, the image pickup element 103, the analog processing unit 105, the A/D conversion unit 107 totally function as an image pickup unit for capturing a subject and acquiring the image of the subject. In this specification, the raw image data before the image processing by the image processing unit 109 is expressed as RAW image data.

The image pickup element 103 has a built-in electronic shutter. When a shooting operation is repeatedly performed during capturing moving pictures and live views, the built-in electronic shutter function in the image pickup element 103 is used for shooting with the mechanical shutter 101 opened.

The bus 110 is a transfer path for transferring various types of data read or generated in the camera body 100 internally to the inside of the camera body 100. Connected to the bus 110 in addition to the above-mentioned A/D conversion unit 107 are an image processing unit 109, an auto exposure (AE) processing unit 111, an auto focus (AF) processing unit 113, an image compression/decompression unit 117, a communication unit 119, a microcomputer 121, the synchronous DRAM (SDRAM) 127, a memory interface (I/F) 129, and a display driver 133.

The image processing unit 109 includes a basic image processing unit 109a for performing basic image processing, a special image processing unit 109b for applying a special effect when a mode in which the special effect such as an art filter etc. is applied is set, a combined image processing unit 109c for generating image data of a combined image, and a subject detection unit 109d for analyzing the image data by pattern matching process etc., and detecting a subject. The image processing unit 109 reads the image data temporarily stored in the SDRAM 127 and performs the image processing on the image data.

The basic image processing unit 109a performs on the RAW image data an optical black (OB) subtracting process, a white balance (WB) correction, a synchronization process performed on Bayer data, a color reproduction process, a brightness changing process, an edge enhancing process, a noise reduction (NR) process, etc.

The special image processing unit 109b performs special image processing in which various types of visually special effects depending on a set special effect (art filter) etc. on the image data process by the basic image processing unit 109a. For example, when a toy photo (pin hole) is set, a process of adding shading is performed. If a fantasic focus (soft focus), a rough monochrome (grainy film), a diorama, a crystal (star light), a white edge, a partial color are set, then a soft focus process (soft focus effect), a noise superposition process, a gradation process, a cross-filter (star light effect) process, a process of whitening the periphery, and a process of applying a monochrome process to the areas other than a specified color area are performed respectively.

The combined image processing unit 109c generates the image data of a combined image as an image obtained by combining plural pieces of image data and laying out a plurality of images corresponding to the plural pieces of image data for a specified arrangement. The plural pieces of image data to be combined are the image data processed by at least the basic image processing unit 109a, and when a special effect is set, the image data processed by the basic image processing unit 109a and the special image processing unit 109b are combined.

Before combining the image data, the combined image processing unit 109c corrects the images (that is frame images configuring the combined image). Concretely, a feature value indicating the feature of a frame image is calculated from a frame image, and the image is corrected so that the calculated feature value may approach a target (hereafter referred to as a target feature value). The feature value of each frame image approaches the target feature value by the correction, thereby reducing the difference in feature value between the frame images. As a result, the combined image looks unified as a whole.

It is not necessary to correct all frame images by the combined image processing unit 109c. If two or more frame images are corrected, the appearance of the combined image is improved in unified appearance as a whole. Furthermore, as compares with a large frame image, it is considered that a small frame image less significantly affects the unified appearance as a whole. Therefore, the correction may be performed only on a large frame image or may be performed on a large frame image on a priority basis. Furthermore, for example, when the feature value of a specific frame image is set as a target feature value, there is the possibility that the unified appearance as a whole is improved although only one of the other frame images is corrected. Therefore, the combined image processing unit 109c only has to correct at least one frame image, and it is preferable that two or more frame images are corrected.

The combined image processing unit 109c performs the process of adding a special effect on the image data of a generated combined image. By adding the special effect to the entire combined image, the unified appearance as a whole of the combined image may be further improved.

The subject detection unit 109d performs the process of detecting a specified subject, for example, the face of a person, a pet animal, etc. by analyzing an image using a pattern matching technique etc. Furthermore, the process of calculating the type, size, position, etc. of a detected subject may be performed. The detection results may be used in, for example, switching a shooting mode, autofocus, auto-zoom in which a subject image is captured in fixed size, etc.

The AE processing unit 111 measures the subject brightness based on the image data input through the bus 110, and outputs the obtained subject brightness information to the microcomputer 121 through the bus 110. In this example, the AE processing unit 111 calculates the subject brightness based on the image data, but the camera 1 may realize a similar function by providing a photometric sensor dedicated for measuring subject brightness.

The AF processing unit 113 extracts a signal of a high frequency component from image data, and acquires a focusing evaluation value by an accumulating process. The AF processing unit 113 outputs the acquired focusing evaluation value to the microcomputer 121 through the bus 110. That is, the camera 1 adjusts the focus of the taking lens 201 in the so-called contrast method.

When recording image data in a recording medium 131 connected to the memory I/F 129, the image compression/decompression unit 117 compresses image data read from the SDRAM 127 in the compression system such as the JPEG etc. for a still image, and in the compression system such as the MPEG etc. for moving pictures.

The microcomputer 121 generates a JPEG file, an MPO file, and an MPEG file by adding a necessary header for configuring the JPEG file, the MPO file, and the MPEG file to JPEG image data and MPEG image data. The microcomputer 121 records the generated file in the recording medium 131 through the memory I/F 129.

The image compression/decompression unit 117 also decompresses JPEG image data and MPEG image data for regenerating and displaying an image. When decompressing image data, the image compression/decompression unit 117 reads a file recorded in the recording medium 131, performs a decompressing process on the file, and temporarily stores the decompressed image data in the SDRAM 127. In the present embodiment, an example of adopting the JPEG compression system and the MPEG compression system is described, but the compression system is not limited to these systems, but other systems such as TIFF, H.264, etc. may be used.

The communication unit 119 communicates with an external equipment unit to update or add a template stored in flash memory 125 described later. The communication unit 119 may be connected to the external equipment unit through a cable LAN and a wireless LAN, or through a USB cable etc.

The microcomputer 121 functions as a control unit of the entire camera 1, and totally controls various sequences of the camera. In addition to the above-mentioned I/F 300, the operating unit 123 and the flash memory 125 are connected to the microcomputer 121.

The operating unit 123 includes operation members as various input buttons, keys, etc. such as a power supply button, a release button, a moving picture button, a regeneration button, a menu button, a cross button, an OK button, a mode dial etc., detects the operation states of these operation members, and outputs a detection result to the microcomputer 121. The microcomputer 121 executes various sequences depending on the operation of a user based on the detection result of the operation member from the operating unit 123. That is, in the camera 1, the operating unit 123 functions as a reception unit which receives various instructions (for example, a shoot instruction, a cancel instruction, a reconstruct instruction, a regenerate instruction, etc.) from a user.

The power supply button is an operation member for ON/OFF instruction for power supply of the camera 1. When the power supply button is pressed, the power supply of the camera 1 is turned on, and when the power supply button is pressed again, the power supply of the camera 1 is turned off.

The release button is connected to a first release switch which is placed in the ON position by half pressing, and a second release switch which is placed in the ON position by full pressing further from the half pressing. When the first release switch is placed in the ON position, the microcomputer 121 executes a shooting preparation sequence such as an AE operation, an AF operation, etc. When the second release switch is placed in the ON position, the microcomputer 121 controls the mechanical shutter 101 etc., acquires image data based on a subject image from the image pickup element 103 etc., and executes a series of operating sequences by recording the image data in the recording medium 131, thereby performing the shooting operation.

The regeneration button is an operation button for setting and releasing a regeneration mode. When the regeneration mode is set, the image data of a shot image is read from the recording medium 131, and the image is regenerated and displayed on the display panel 135.

The menu button is an operation button for display of a menu screen on the display panel 135. On the menu screen, various camera settings may be performed. A special effect (art filter) may be used as a camera setting. Various special effects may be used as a special effect such as a fantasic focus, a pop, an art, a toy photo, a rough monochrome, a diorama, etc. Otherwise, a combined image setting may be performed on the menu screen.

The mode dial is an operation dial for selection of the shooting mode. With the camera 1, the shooting mode is switched between the normal mode in which a normal shooting operation is performed and the combined image mode in which a combined image is shot. Each mode is concretely described below. That is, in the normal mode, a live view image is displayed on the entire display panel 135 before the shooting operation, and a shot image is displayed on the entire display panel 135 after the shooting operation. In this mode the image data of one image is generated in one shooting operation. On the other hand, in the combined image mode, before the shooting operation, a live view image is displayed in one of the plurality of areas (hereafter referred to as display areas) for display of an image as defined on the display panel 135, and after the shooting operation, a shot image is displayed in the display area on which the live view image has been displayed after the shooting operation, and a live view image is displayed in another display area. In the combined image mode, since the image data of one frame image which configures a combined image in one shooting operation is generated, a plurality of shooting operations are normally performed to acquire one combined image.

The operating unit 123 further includes a touch input unit 124. The touch input unit 124 is, for example, a touch panel sensor which is arranged by superposing on the display panel 135. The touch input unit 124 detects a touching operation of a user on the display panel 135, and outputs a detection result to the microcomputer 121. The microcomputer 121 executes various sequences depending on the user operation based on the detection result of the touch input unit 124 from the operating unit 123.

The operating unit 123 may be configured by providing the above-mentioned buttons on the display panel 135. That is, instead of physically providing a button on the surface of the camera 1, the button may be displayed on the display panel 135 and the touch input unit 124 detects the operation performed on the button displayed on the display panel 135. Furthermore, instead of displaying the release button on the display panel 135, the display panel 135 may also function as a release button. In this case, when the display panel 135 is touched, or when the display area in which a live view image is displayed on the display panel 135 is touched, it is assumed that the release button has been half pressed, and that the release button has been fully pressed when it is continuously touched for a specified time (for example, one second) or longer. Otherwise, it may be assumed that when a touching operation is performed, the release button has been half pressed and fully pressed.

The flash memory 125 stores a program for execution of various sequences of the microcomputer 121. The microcomputer 121 controls the entire camera according to the program stored in the flash memory 125. Furthermore, the flash memory 125 stores various adjustment values such as an R gain and a B gain depending on the white balance mode, a gamma conversion table, an exposure condition determination conversion table, etc. The flash memory 125 may also store a correction target described later. Furthermore, the flash memory 125 stores as a template the information about a combined image style, that is, how a frame image configuring a combined image is laid out, etc. The program may be stores in the recording medium 131 instead of the flash memory 125, and the microcomputer 121 may read and execute the program recorded in the recording medium 131.

The SDRAM 127 is volatile memory which may be electrically written for temporarily storing image data etc. The SDRAM 127 temporarily stores image data output from the A/D conversion unit 107 and image data processed by the image processing unit 109, the image compression/decompression unit 117, etc.

The memory I/F 129 is connected to the recording medium 131. The memory I/F 129 performs control of a write and a read on the recording medium 131 of image data and data such as a header etc. added to the image data. The recording medium 131 is a recording medium such as a freely attached and detached memory card etc., but is not limited to the recording medium, but may be non-volatile memory, a hard disk, etc. built in the camera body 100.

The display driver 133 is connected to the display panel 135. The display driver 133 displays an image on the display panel 135 based on the image data which is read from the SDRAM 127 and the recording medium 131 and is decompressed by the image compression/decompression unit 117. The display panel 135 is, for example, a liquid crystal display (LCD) provided at the back of the camera body 100, and displays an image. The image display includes reck view display in which image data to be recorded is displayed for a short time immediately after shooting, regeneration display in which an image file of still images and moving pictures recorded in the recording medium 131 is regenerated and displayed, and moving picture display in which moving pictures such as live view image are displayed. The display panel 135 may be an organic EL in addition to an LCD, and may be other display panels.

The layout of a plurality of display areas defined when the shooting mode is a combined image mode is determined by the style of combined image.

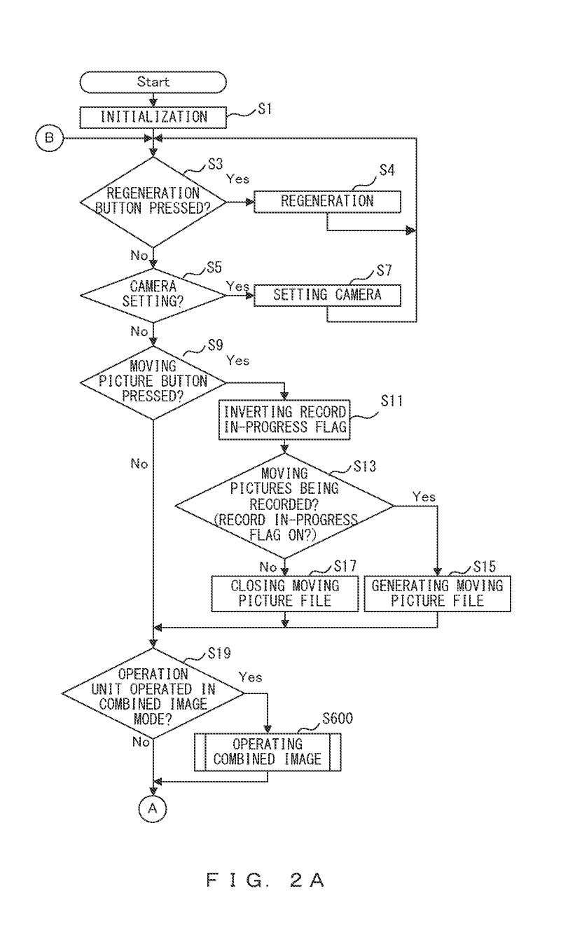

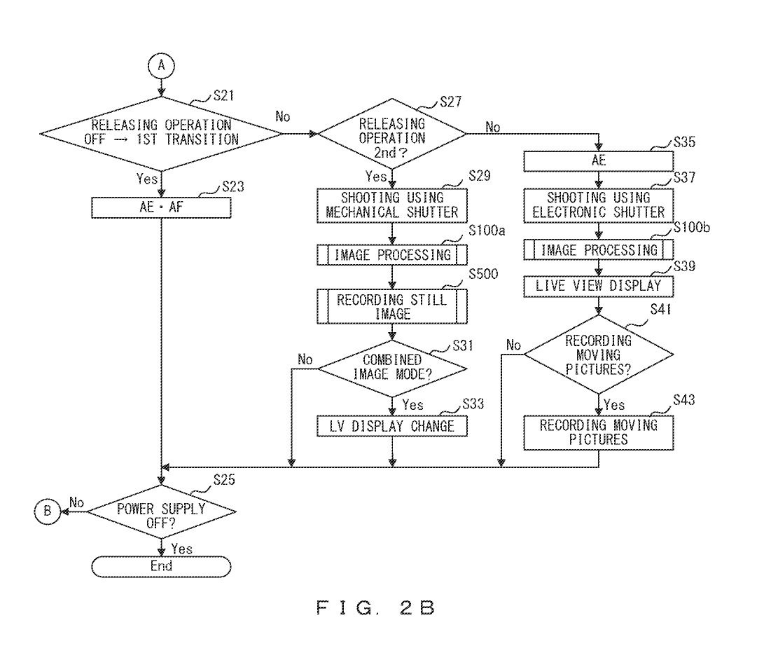

Next, the process performed by the camera 1 with the above-mentioned configuration is described below with reference to FIGS. 2A through 8. The process of the camera illustrated by the flowchart in FIGS. 2A through 8 is performed by the microcomputer 121 executing the program stored in the flash memory 125. Explained first is the flow of the entire process of the camera illustrated in FIGS. 2A and 2B.

When the power supply button in the operating unit 123 is operated to turn on the camera 1, and the process of the camera 1 illustrated in FIGS. 2A and 2B is started, the microcomputer 121 initializes the camera 1 (step S1). In this example, mechanical initialization and electrical initialization such as initializing various flags etc. are performed. A flag to be initialized is, for example, a record in-progress flag etc. indicating whether or not moving pictures are being recorded, and the record in-progress flag is set as an OFF state by the initialization.

When the initialization is completed, the microcomputer 121 next judges whether or not the regeneration button has been pressed (step S3). In this step, the microcomputer 121 detects the operating state of the regeneration button in the operating unit 123 for judgment. When the regeneration button is displayed on the display panel 135, the microcomputer 121 detects the signal from the touch input unit 124 for judgment. When the regeneration button is pressed, the microcomputer 121 sets the regeneration mode as an operation mode, regenerates the image data recorded in the recording medium 131, and displays the data on the display panel 135, thereby performing the regenerating process (step S4) When the regenerating process is completed, the process in step S3 is performed again.

If it is judged in step S3 that the regeneration button has not been pressed, the microcomputer 121 judges whether or not the menu button has been pressed, that is, whether or not the menu screen is displayed to allow a camera setting (step S5). In this step, the microcomputer 121 detects the operating state of the menu button in the operating unit 123 for judgment. When the menu button is displayed on the display panel 135, the microcomputer 121 detects the signal from the touch input unit 124 for judgment.

When the menu button is pressed, the microcomputer 121 detects a further operation for the operating unit 123, and changes the camera setting depending on the detection result (step S7) When the camera setting process is completed, the process in step S3 is performed again.

A camera setting may be, for example, a shooting mode setting, a record mode setting, an image finish setting, a combined image style setting, a setting of selection of an image acquired in advance to be incorporated into a combined image, a setting as to whether or not a frame image is to be recorded, etc. The shooting mode may be a normal shooting mode and a combined image mode. The record mode includes JPEG record, JPEG+RAW record, RAW record, etc. as a still image record mode, and motion-JPEG, H.264, etc. as a moving pictures record mode. Furthermore, an image finish setting may be a natural appearance image setting (natural), a vivid appearance image setting (vivid), a moderate appearance image setting (flat), and also a special effect setting such as an art filter.

When it is judged in step S5 that the menu button has not been pressed, the microcomputer 121 judges whether or not the moving picture button has been pressed (step S9). In this step, the microcomputer 121 detects the operating state of the moving picture button in the operating unit 123 for judgment. When the moving picture button is displayed on the display panel 135, the microcomputer 121 detects the signal from the touch input unit 124 for judgment.

If it is judged that the moving picture button has not been pressed, the microcomputer 121 performs the process in step S19. On the other hand, if the moving picture button is pressed, the microcomputer 121 inverts the record in-progress flag (step S11). That is, if the record in-progress flag indicates OFF, it is set as ON, and if the record in-progress flag indicates ON, it is set as OFF. Furthermore, the microcomputer 121 judges whether or not an image is being recorded according to the state of the inverted record in-progress flag (step S13).

If it is judged that the record in-progress flag indicates ON, the microcomputer 121 judges that the start of recording moving pictures is specified, generates a moving picture file (step S15), and prepares for recording image data. The process is performed when, for example, the moving picture button is pressed first after power-up. After generating the moving picture file, the process in step S19 is performed.

If it is judged in step S13 that the record in-progress flag indicates OFF, the microcomputer 121 judges that the completion of recording moving pictures is specified, and closes the moving picture file (step S17). That is, after setting the moving picture file in a regeneration enabled state by performing the process etc. of recording the number of frames in the header of the moving picture file, the writing process terminates. After completing the write to the moving picture file, the process in step S19 is performed.

In step S19, the microcomputer 121 judges whether or not the shooting mode is the combined image mode, and a specified combined image operation has been performed on the operating unit 123. In this step, the microcomputer 121 detects the setting of the shooting mode stored in the SDRAM 127 and the operating state of the operating unit 123 for judgment.

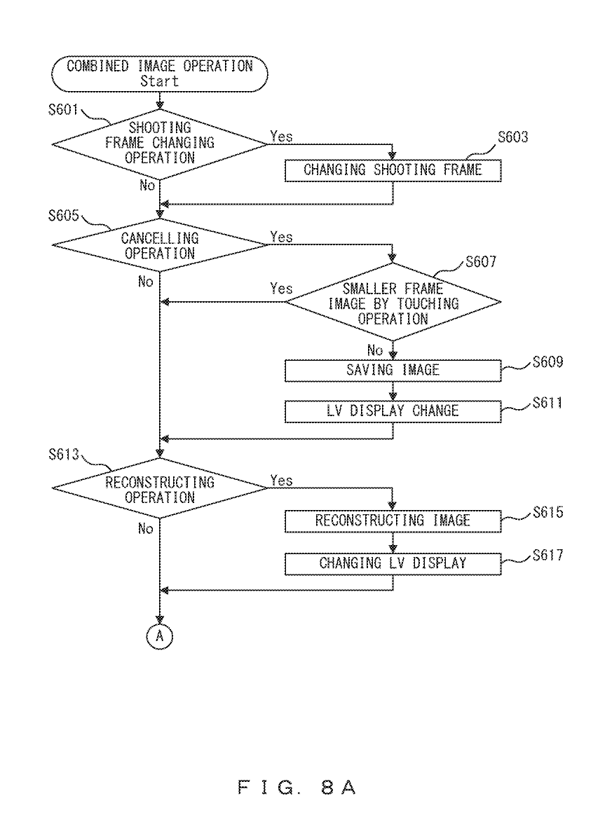

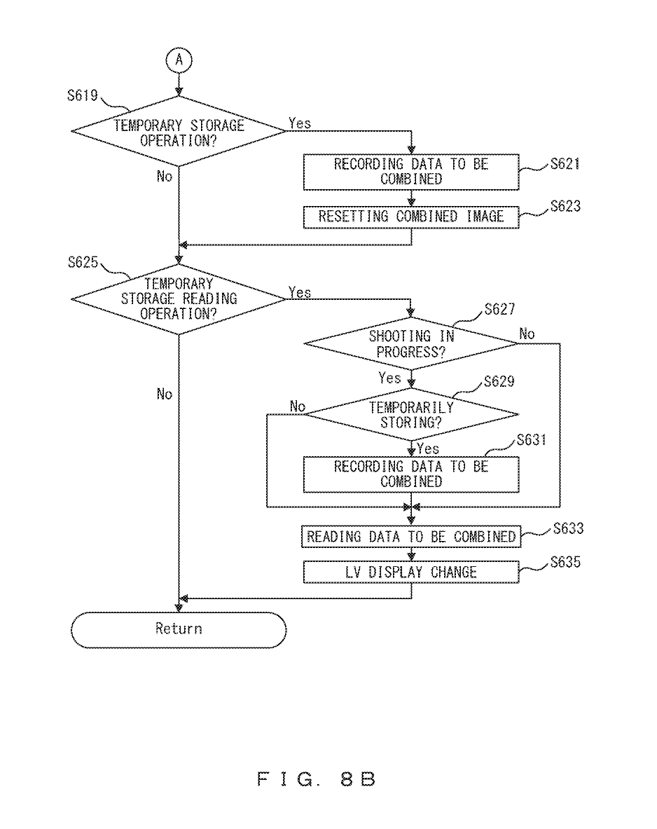

When it is judged that a specified operation is performed in the combined image mode, the microcomputer 121 performs a combined image operating process (step S600). When the combined image operating process is completed, the process in step S21 is performed. The combined image operating process is described later in detail with reference to FIGS. 8A and 8B.

If it is judged in step S19 that the shooting mode is not the combined image mode or the specified combined image operation is not performed, the microcomputer 121 judges whether or not the release button has been half pressed (step S21). In this step, the microcomputer 121 detects for judgment the change of the first release switch, which cooperates with the release button, from the OFF state to the ON state. When the release button is displayed on the display panel 135 or the display panel 135 functions as a release button, the microcomputer 121 detects for judgment a signal indicating that the area in which the release button is displayed or the display area in which the live view image is displayed has been touched.

When the release button is half pressed, the microcomputer 121 performs the AE/AF operation (S23). In this step, the AE operation is performed by the AE processing unit 111 detecting the subject brightness based on the image data acquired by the image pickup element 103, and calculating the shutter speed, the stop value, etc. according to which the appropriate exposure is determined based on the subject brightness. The AF operation is performed by the driver 205 moving the focal position of the taking lens 201 through the microcomputer 207 in the interchangeable lens 200 so that the focusing evaluation value acquired by the AF processing unit 113 may be the peak value. When the AF operation is performed according to the signal from the touch input unit 124, the taking lens 201 is moved so that the focal point may be obtained at the subject displayed in the touch position. After the AE/AF operation, the process in step S25 is performed.

The AF operation may be adopted in various AF systems such as a phase difference AF using a dedicated sensor in addition to the above-mentioned so-called contrast AF.

If it is judged in step S21 that the release button is not half pressed, the microcomputer 121 judges whether or not the release button has been fully pressed (step S27). In this step, the change of the second release switch from the OFF state to the ON state is detected for judgment. By detecting for judgment that the second release switch is in the OFF state, a consecutive shooting operation may be performed. When the release button is displayed on the display panel 135 or the display panel 135 functions as a release button, a signal indicating that the area where the release button is displayed or the display area where the live view image is displayed is touched is detected for judgment.

When the release button is fully pressed, the microcomputer 121 performs a still image shooting operation using the mechanical shutter (S29). In this step, the stop 203 is controlled by the stop value calculated in step S23, and the shutter speed of the mechanical shutter 101 is controlled at the calculated shutter speed. When the exposure time depending on the shutter speed passes, an image signal is read from the image pickup element 103, and the RAW image data processed by the analog processing unit 105 and the A/D conversion unit 107 is temporarily stored in the SDRAM 127 through the bus 110.

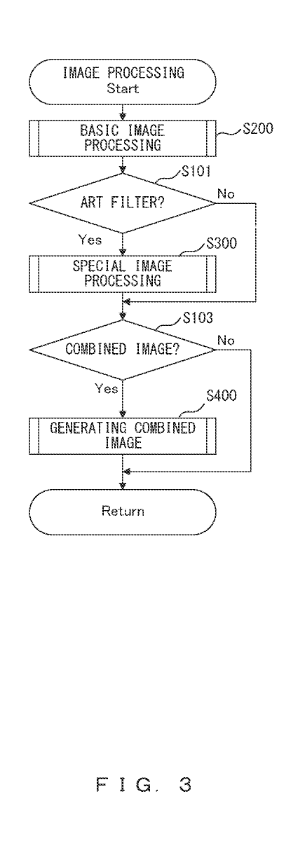

Then, the microcomputer 121 reads the RAW image data temporarily stored in the SDRAM 127, allows the image processing unit 109 to perform the image processing (step S100a), and performs the still image recording process of recording the processed image data etc. in the recording medium 131 (step S500). The image processing and the still image recording process are described later in detail with reference to FIGS. 3 through 6 and 7 respectively.

When the still image recording process is completed, the microcomputer 121 judges whether or not the shooting mode is the combined image mode (step S31). In this step, a judgment is made by the setting of the shooting mode stored in the SDRAM 127.

When the shooting mode is not the combined image mode, that is, when it is the normal shooting mode, the microcomputer 121 performs the process in step S25. On the other hand, when the shooting mode is the combined image mode, the microcomputer 121 changes the live view display (step S33). With the camera 1, when the shooting mode is the combined image mode, the display panel 135 has a plurality of display areas, and one of the display areas displays a live view image by the process in step S39 as described later. In the process of changing the live view display in step S33, the display driver 133 controls the display panel 135 so that the display area in which a live view image is displayed may be changed under the control of the microcomputer 121. To be more concrete, the image displayed in the display area where the live view image has been displayed changed into the image shot in step S29 and processed in step S100a. Furthermore, the display area where the live view image is to be displayed is switched to display the live view image in another display area. That is, with the camera 1, the microcomputer 121 and the display driver 133 function as a display control unit for controlling the display panel 135. After the live view display processing, the microcomputer 121 performs the process in step S25.

If it is judged in step S27 that the release button has not been fully pressed, the microcomputer 121 performs the AE operation for moving pictures or a live view image (step S35). The AE operation is performed by the AE processing unit 111 calculating the shutter speed and the ISO sensitivity of the electronic shutter in the image pickup element 103 so that the live view display may be performed at the appropriate exposure. After the AE operation, the microcomputer 121 performs a shooting operation using an electronic shutter (step S37). In this step, an image signal is read from the image pickup element 103 using the electronic shutter, and the RAW image data processed by the analog processing unit 105 and the A/D conversion unit 107 are temporarily stored in the SDRAM 127 through the bus 110.

Then, the microcomputer 121 reads the RAW image data temporarily stored in the SDRAM 127, and allows the image processing unit 109 to perform the image processing similar to the shooting operation performed using the mechanical shutter (step S100b). Furthermore, under the control of the microcomputer 121, the display driver 133 controls the display panel 135 so that a live view image may be updated by changing the image in the display area in which the live view image is displayed into the image data obtained by image processing in step S100b after the acquisition in step S37 (step S39).

When the live view image is updated, the microcomputer 121 judges whether or not moving pictures are being recorded (step S41). In this step, the judgment is made based on the state of the record in-progress flag stored in the SDRAM 127.

When the record in-progress flag is indicates OFF, the microcomputer 121 performs the process in step S25. On the other hand, if the record in-progress flag indicates ON, the microcomputer 121 judges that the microcomputer 121 is recording moving pictures, and performs moving picture record processing (step S43). That is, the image data of the live view image updated in step S39 is recorded as a frame image of the moving picture file generated in step S15. Then, the process in step S25 is performed.

In step S25, the microcomputer 121 judges whether or not the power supply is OFF. When the power supply is ON, the process in step S3 is performed. When it is OFF, the microcomputer 121 terminates the process of the camera 1 after performing the necessary terminating process.

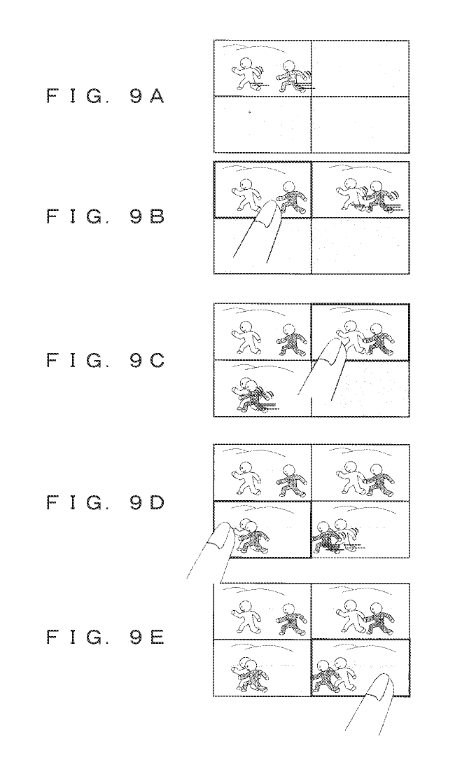

With the camera 1 which operates as described above, for example, when a subject which moves with the lapse of time is shot in the combined image mode, a frame image which configures a combined image is easily acquired by touching the display area in which the live view image is displayed as illustrated in FIGS. 9A through 9E, thereby changing the image displayed in the touched display area into the acquired frame image from the live view image. That is, the operation of touching a live view image corresponds to a shoot instruction. Furthermore, since the area in which a live view image is displayed is automatically switched, and the live view image is displayed in another display area in which a frame image (including an image which is acquired in advance and is to be incorporated into a combined image) is not being displayed, the next frame image may be immediately acquired without losing a shutter chance although a subject is moving. Furthermore, since a live view image is displayed in only one display area in a plurality of defined display areas on the display panel 135, an environment in which a user may easily concentrate on shooting an image may be provided for the user.

Described next in more detail with reference to FIGS. 3 through 6 is the image processing which is performed after an image is shot using a mechanical shutter or after the image is shot using an electronic shutter as illustrated in FIG. 2B. The target of the image processing performed after the shooting operation using a mechanical shutter is RAW image data acquired in the shooting operation using a mechanical shutter, and the target of the image processing performed after the shooting operation using an electronic shutter is RAW image data acquired in the shooting operation using an electronic shutter.

The image processing is configured mainly by basic image processing performed by the basic image processing unit 109a, special image processing performed by the special image processing unit 109b, and combined image generating process performed by the combined image processing unit 109c.

When the microcomputer 121 reads the RAW image data temporarily stored in the SDRAM 127 and instructs the image processing unit 109 to perform the image processing, the basic image processing unit 109a first performs the basic image processing on the read RAW image data (step S200).

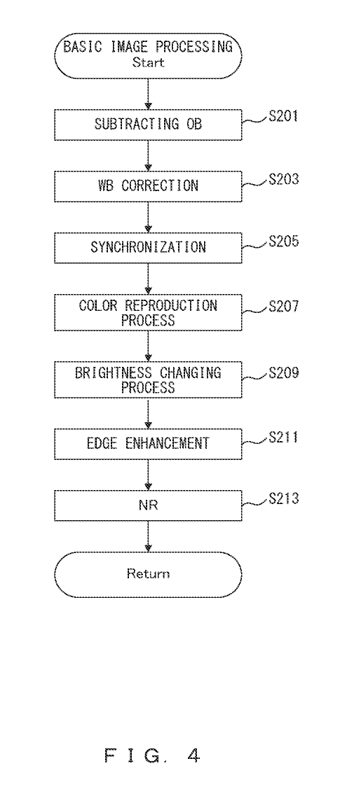

The basic image processing performed by the basic image processing unit 109a is configured by seven image processing steps as illustrated in FIG. 4. First, an optical black (OB) subtraction is performed (step S201). In this step, the OB operation unit in the basic image processing unit 109a subtracts an optical black value obtained from a dark current etc. of the image pickup element 103 from the pixel value of each pixel which configures image data.

After the OB subtraction, a white balance (WB) correction is made (step S203). In this step, the WB correction unit in the basic image processing unit 109a performs a WB correction on image data depending on the set white balance mode. Concretely, the correction is made by reading an R gain and a B gain depending on the white balance mode set by a user from the flash memory 125 of the camera body, and multiplying the image data by the read value. Otherwise, in the auto-white-balance, the R gain and the B gain are calculated from the RAW image data, and a correction is made using the result.

Next, a synchronization process is performed (step S205). In this step, the synchronization processing unit in the basic image processing unit 109a converts the data of each pixel (Bayer data) configuring the image data on which a WB correction is performed into RGB data. Concretely, data not included in the pixel is obtained from the periphery by interpolation, and convert the data into RGB data. This step is omitted when one pixel in RAW image data includes plural pieces of data in the case in which an image pickup element in FOVEON (registered trademark of Foveon Inc.) format is used as the image pickup element 103.

After the synchronization processing, a color reproduction process is performed (step S207). In this step, a color reproduction processing unit in the basic image processing unit 109a performs a linear conversion performed by a multiplication by a color matrix coefficient depending on the white balance mode set for image data and thereby corrects the color of image data. Since the color matrix coefficient is stored in the flash memory 125, it is read from the memory and used.

After the color reproduction processing, a brightness changing process is performed (step S209). In this step, a brightness changing process unit in the basic image processing unit 109a performs a gamma correcting process on image data (RGB data). Furthermore, the RGB data is color converted into YCbCr data, and a gamma correction is made to Y data of the converted image data. In the gamma correction, a gamma conversion table stored in the flash memory 125 is read and used.

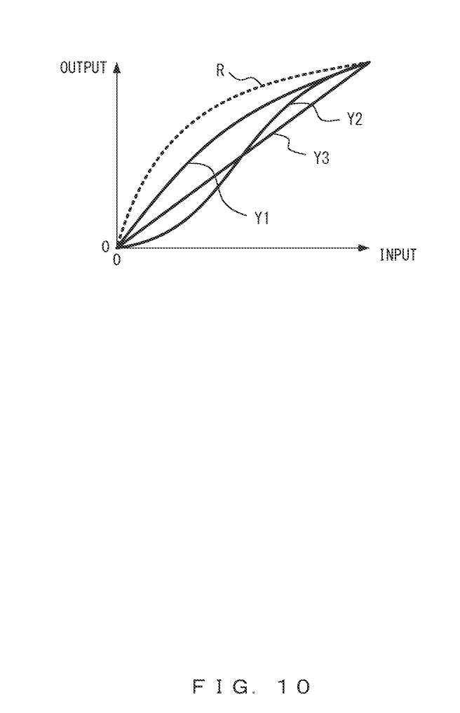

FIG. 10 exemplifies a gamma conversion table used in the brightness changing process in step S209. FIG. 10 exemplifies a single conversion table R used in the gamma correcting process on the RGB data, and a plurality of different conversion tables (conversion table Y1, Y2, and Y3) used depending on the setting of an art filter in the gamma correcting process on the Y data in the YCbCr data. A conversion table Y1 is used when a fantasic focus is set. A conversion table Y2 is used when a pop art or a toy photo is set. A conversion table Y3 is used when other settings are made. The gamma correcting process on the RGB data may be performed using a different conversion table for each setting of an art filter as in the gamma correcting process on the Y data.

After the brightness changing process, an edge enhancing process is performed (step S211). In this step, an edge enhancing process unit in the basic image processing unit 109a extracts an edge component using a band pass filter, and adds a result of a multiplication of the component by a coefficient depending on the edge enhancement level to image data, thereby enhancing the edge of the image data.

Finally, a noise removing (NR) process is performed (step S213). In this step, the NR unit in the basic image processing unit 109a analyzes the frequency of an image, and performs a coring process depending on the frequency, thereby reducing the noise.

When the above-mentioned basic image processing is completed, and if a special effect (art filter) is set, then the special image processing unit 109b performs the special image processing on the image data processed by the basic image processing unit 109a (steps S101 and S300 in FIG. 3).

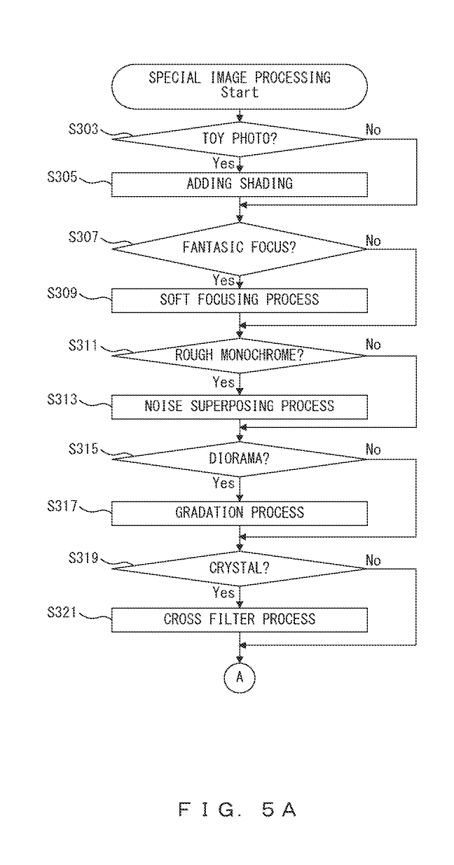

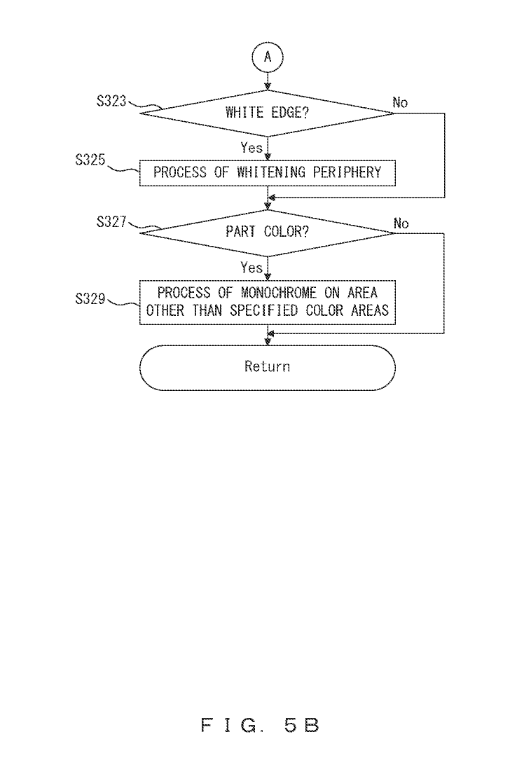

The special image processing performed by the special image processing unit 109b is configured mainly by seven image processing steps performed depending on the setting of a special effect as illustrated in FIGS. 5A and 5B. Concretely, it is sequentially judged whether or not a toy photo, a fantasic focus, a rough monochrome, a diorama, a crystal, a white edge, and a part color are set as special effects (art filters) (steps S303, S307, S311, S315, S319, S323, and S327).

When the toy photo is set, a shading adding process is performed on the image data (step S305). In this step, the special image processing unit 109b generate a gain map (gain value is 1 or less) in which the brightness is gradually reduced depending on the distance from the center, and multiplies the image data by a gain depending on each pixel according to the gain map, thereby adding shading to the periphery.

When the fantasic focus is set, a soft focus process is performed on the image data (step S309). In this step, the special image processing unit 109b generates image data by performing a shading process on the entire image, and combines the image data of the image before performing the shading process with the image data of the image after the shading process at a specified ratio (for example 3:2 etc.).

When the rough monochrome is set, a noise superposing process is performed on the image data (step S313). In this step, the special image processing unit 109b adds a prepared noise pattern to the image data. The noise pattern may be generated based on a random number etc.

When the diorama is set, the gradation process is performed on the image data (step S317). In this step, the special image processing unit 109b gradually applies gradation depending on the distance to the periphery (for example, above and below, left and right, or both) of the image centered the target of the AF.

When the crystal is set, a cross filter process is performed on the image data (step S321). In this step, the special image processing unit 109b detects a brightness point in an image, and processes the image data so that the cross pattern may be drawn with the brightness point set at the center.

When the white edge is set, the process of whitening the periphery is performed on the image data (step S325). In this step, the feature of gradually increasing the ratio of the white part depending on the distance from the center of the image is designed in advance, and the special image processing unit 109b processes each piece of pixel data of the image depending on the feature.

When the part color is set, the process of setting monochrome for the areas other than a specified color area is performed (step S329). In this step, the special image processing unit 109b converts the pixel data other than the data of the specified color set in advance into monochrome pixel data.

When the above-mentioned special image processing is completed, the combined image processing unit 109c judges whether or not the shooting mode is the combined image mode (step S103 in FIG. 3). When the shooting mode is not the combined image mode, the image processing terminates.

When the shooting mode is the combined image mode, the combined image processing unit 109c performs the combined image generating process using the image data of plural images displayed in the plural display areas of the display panel 135 (step S400 in FIG. 3).

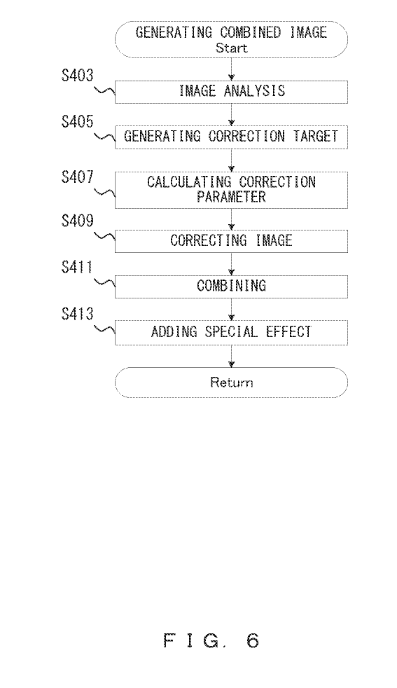

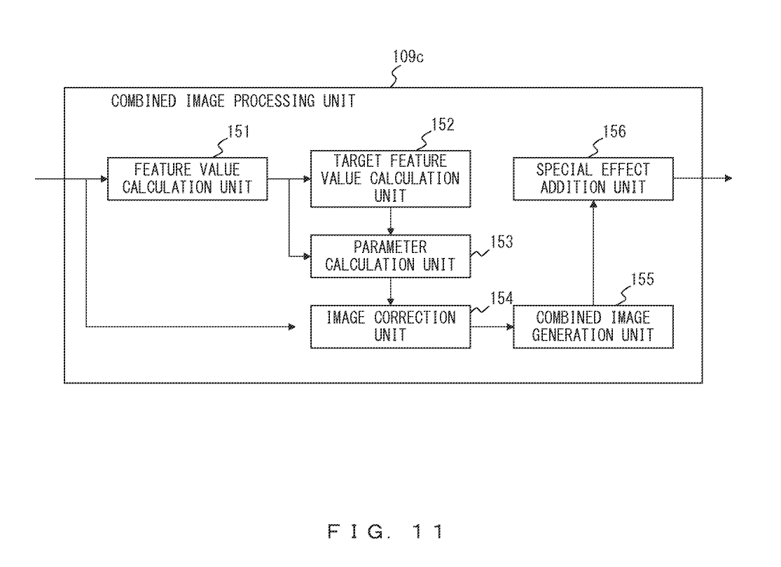

The combined image generating process performed by the combined image processing unit 109c is configured by six image processing steps as illustrated in FIG. 6, and the process performed in each step is performed by various functions of the combined image processing unit 109c illustrated in FIG. 11.

First, an image analysis is performed on each frame image on which the basic image processing (and special image processing) has been performed (step S403). In this step, a feature value calculation unit 151 illustrated in FIG. 11 analyzes each frame image, and calculates the feature value indicating the feature of each image. A feature value may be, for example, the brightness distribution of a frame image, the color difference signal distribution, the hue distribution, or the color saturation distribution, and it is preferable that at least one of them is included.

After the image analysis, one correction target is generated with respect to a plurality of frame images (step S405). In this step, a target feature value calculation unit 152 illustrated in FIG. 11 calculates a target feature value as a correction target from the feature value calculated by the feature value calculation unit 151. The target feature value is, for example, the average of the feature values of a plurality of frame images, the feature value of the first analyzed frame image, the feature value of the last analyzed frame image, feature value calculated by weighting the feature value of each frame image, etc. That is, it may be calculated from the feature value of plural pieces of image data or may be calculated from the feature value of a single piece of image data. The target feature value does not always have to be calculated as a distribution like the feature value calculated by the feature value calculation unit 151, and may be calculated a specified value as a target feature value. For example, if a feature value is a color difference signal distribution, the target feature value may be the color difference indicated by the peak of the color difference signal distribution, the color difference indicated by the center of the color difference signal distribution.

Then, a correction parameter for correction of frame image data is calculated for each frame image (step S407). In this step, a parameter calculation unit 153 illustrated in FIG. 11 calculates for each frame image a correction parameter which allows the feature value of a corrected frame image to approach the target feature value from the feature value calculated by the feature value calculation unit 151 and the target feature value calculated from the target feature value calculation unit 152.

When a correction parameter is calculated, the image correction process of correcting each frame image is performed so that the feature value calculated by the feature value calculation unit 151 may approach the target feature value (step S409). In this step, an image correction unit 154 corrects each frame image by the correction parameter calculated for each frame image by the parameter calculation unit 153. Thus, by the approach of the feature value of the corrected frame image to the target feature value, the difference between frame images is reduced.

When the image correction is completed, a plurality of frame images configuring a combined image are combined on a background image (step S411). In this step, the image data of the combined image is generated by a combined image generation unit 155 illustrated in FIG. 11 combining the image data of the plurality of frame images configuring the combined image so that the frame image corrected by the image correction unit 154 may be laid out according to the style of the combined image.

Finally, a special effect is added to the combined image (step S413). In this step, a special effect addition unit 156 illustrated in FIG. 11 performs a process of adding a special effect such as shading, gradation, etc. on the image data of the combined image generated by the combined image generation unit 155. The special effect does not depend on the finish setting by a camera setting. For example, it may be applied depending on the style of combined image. When the processing above is completed, the combined image generating process in FIG. 6 is terminated, thereby terminating the image processing in FIG. 3.

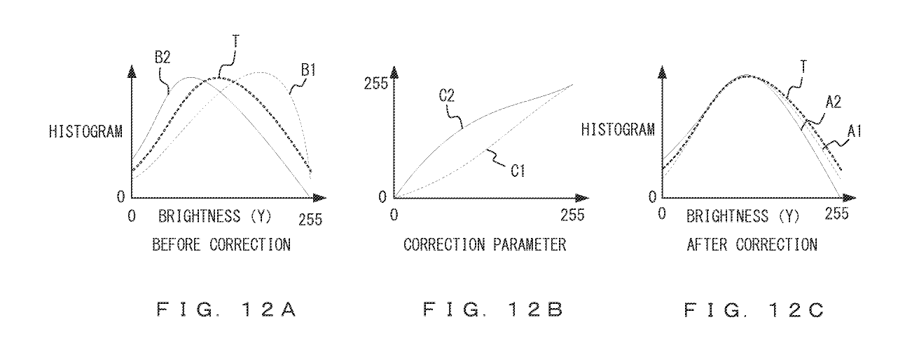

The above-mentioned correcting process on a frame image is described below concretely with reference to FIGS. 12A through 14C by exemplifying the case in which a combined image is configured by two frame images, and the two frame images are corrected.

FIGS. 12A through 12C are an example of a correction by an approach between the brightness distributions of two frame images. In this example, as illustrated in FIG. 12A, the feature value calculation unit 151 first color converts the RGB data of two frame images (first and second images) into YCbCr data, and calculates the brightness distributions (distributions B1 and B2 as brightness histograms) as the feature values of the respective images. Then, the target feature value calculation unit 152 calculates a target brightness distribution as a correction target T from distributions B1 and B2. Next, as illustrated in FIG. 12B, the parameter calculation unit 153 calculates a conversion table C1 in an RGB color space as a correction parameter for correction of the first image having the distribution B1 into an image having a distribution close to the correction target T from the distribution B1 and the correction target T. Similarly, the parameter calculation unit 153 calculates a conversion table C2 in an RGB color space as a correction parameter for correction of the second image having the distribution B2 into an image having a distribution close to the correction target T from the distribution B2 and a correction target T. Finally, the image correction unit 154 corrects the first and second images using the conversion tables C1 and C2, and acquires the corrected first and second images having the brightness distribution (distributions A1 and A2 as a brightness histogram) close to the correction target T illustrated in FIG. 12C.

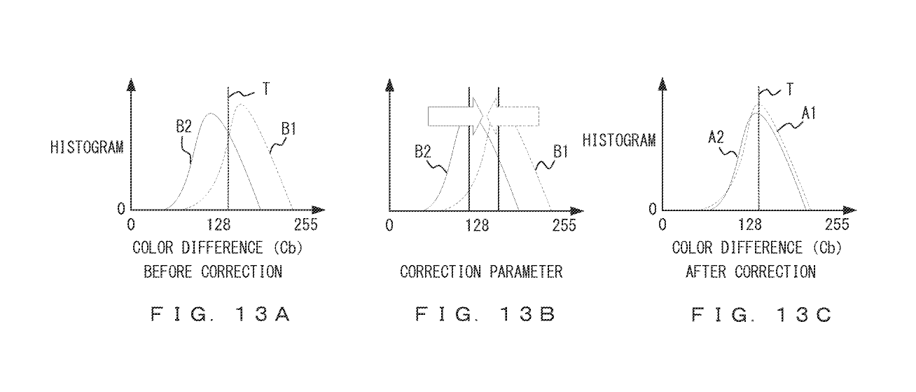

FIGS. 13A through 13C are an example of a correction to reduce the difference between the color difference signal distributions of the Cb components of two frame images. In the example, as illustrated in FIG. 13A, the feature value calculation unit 151 color converts the RGB data of two frame images (first and second images) into YCbCr data, and calculates the color difference signal distribution (distributions B1 and B2 as color difference signal histograms) of the Cb component as a feature value of each image. Then, the target feature value calculation unit 152 calculates the gray scale of the color difference (for example, the gray scale indicated by the peak of the distribution, the gray scale indicated by the center of the distribution, etc.) representing the target color difference signal distribution as the correction target T from the distributions B1 and B2. Next, as illustrated in FIG. 13B, the parameter calculation unit 153 calculates the offset value of the color difference signal distribution from the distribution B1 and the correction target T as the correction parameter for correction of the first image having the distribution B1 so that the gray scale representing the distribution may be a value close to the correction target T. Similarly, the parameter calculation unit 153 calculates the offset value of the color difference signal distribution from the distribution B2 and the correction target T as the correction parameter for correction of the second image having the distribution B2 so that the gray scale representing the distribution may be a value close to the correction target T. Finally, the image correction unit 154 corrects the first and second images using the respective offset values, and acquires the corrected first and second images having the color difference signal distribution (distributions A1 and A2 as color difference signal histograms) in which the gray scale representing the distribution illustrated in FIG. 13C is close to the correction target T. When a part of the corrected distribution exceeds the maximum value or falls below the minimum value of the gray scale, for example, the part may be clipped to the maximum value or the minimum value. Relating to the color difference signal distribution, the distribution different may be reduced by the table conversion as with the correction of the brightness distribution illustrated in FIGS. 12A through 12C.

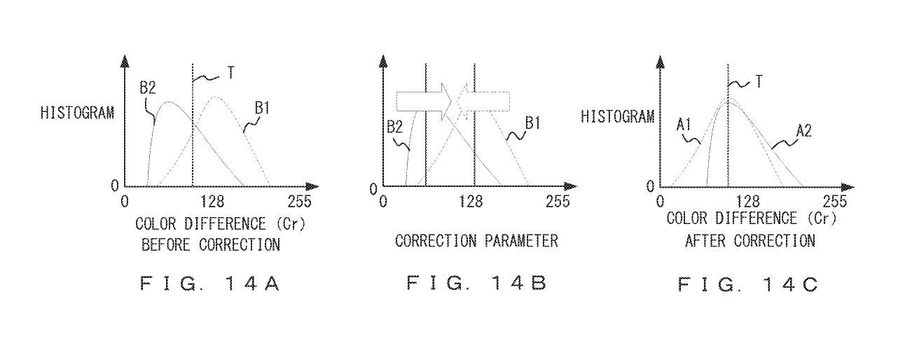

FIGS. 14A through 14C are an example of a correction to reduce the difference between the color difference signal distributions of the Cr components of two frame images. The details are omitted here because the correction is similar to the correction to reduce the difference between the color difference Cb of two frame images illustrated in FIGS. 13A through 13C.

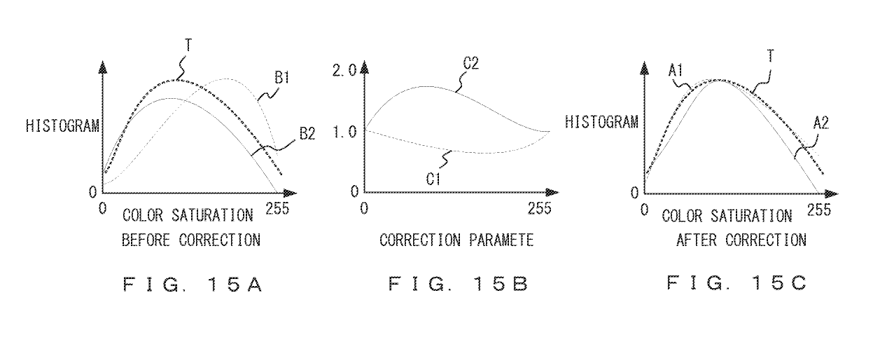

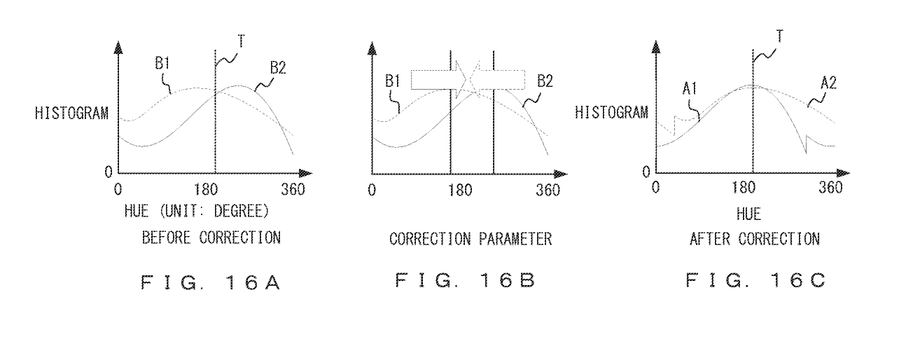

By performing the correction illustrated in FIGS. 12A through 14C, the differences in brightness and color difference between two frame images may be reduced. Therefore, the unified appearance of the laid out combined image may be improved. The combined image processing unit 109c may be not to make all corrections illustrated in FIGS. 12A through 14C, but may improve the unified appearance of the combined image by performing any one correction. FIGS. 15A through 15C and FIGS. 16A through 16C are another concrete example of a case in which a combined image is configured by two frame images, and the two frame images are corrected.

FIGS. 15A through 15C are an example of correction to reduce the difference between the color saturation distributions of two frame images. In this example, as illustrated in FIG. 15A, the feature value calculation unit 151 first color converts the RGB data of two frame images (first and second images) into HSV data, and calculates the color saturation distribution (distributions B1 and B2 as color saturation histograms) as the feature values of the respective images. Then, the target feature value calculation unit 152 calculates a target color saturation distribution as a correction target T from distributions B1 and B2. Next, as illustrated in FIG. 15B, the parameter calculation unit 153 calculates a conversion table C1 indicating the gain for each color saturation from the distribution B1 and a correction target T as a correction parameter for correction of the first image having the distribution B1 into an image having a distribution close to the correction target T. Similarly, the parameter calculation unit 153 calculates a conversion table C2 indicating the gain for each color saturation from the distribution B2 and a correction target T as a correction parameter for correction of the second image having the distribution B2 into an image having a distribution close to the correction target T. Finally, the image correction unit 154 corrects the first and second images using the conversion tables C1 and C2, and acquires the corrected first and second images having the color saturation distribution (distributions A1 and A2 as a color saturation histogram) close to the correction target T illustrated in FIG. 15C.

FIGS. 16A through 16C are an example of a correction to reduce the difference between the hue distributions of two frame images. In the example, as illustrated in FIG. 16A, the feature value calculation unit 151 color converts the RGB data of two frame images (first and second images) into HSV data, and calculates the hue distribution (distributions B1 and B2 as hue histograms) as a feature value of each image. Then, the target feature value calculation unit 152 calculates the angle of the hue representing the target hue distribution as the correction target T from the distributions B1 and B2. Next, as illustrated in FIG. 16B, the parameter calculation unit 153 calculates the offset value of the hue distribution (rotation amount of the hue) from the distribution B1 and the correction target T as the correction parameter for correction of the first image having the distribution B1 so that the angle representing the distribution may be a value close to the correction target T. Similarly, the parameter calculation unit 153 calculates the offset value (rotation amount of the hue) of the hue distribution from the distribution B2 and the correction target T as the correction parameter for correction of the second image having the distribution B2 so that the angle representing the distribution may be a value close to the correction target T. Finally, the image correction unit 154 corrects the first and second images using the respective offset values, and acquires the corrected first and second images having the hue distribution (distributions A1 and A2 as hue histograms) close to the correction target T illustrated in FIG. 16C. The portion whose angle exceeds 360° after the correction is moved to the 0° side, and the portion whose angle falls below 0° is moved to the 360° side, which is different from the case of the color difference.

By performing the correction illustrated in FIGS. 15A through 15C and 16A through 16C, the differences between color saturation of two frame images may be reduced and the differences between hue of two frame images may be reduced. Therefore, the unified appearance of the laid out combined image may be improved. The combined image processing unit 109c may be not to make both corrections illustrated in FIGS. 15A through 15C and 16A through 16C, but may improve the unified appearance of the combined image by performing any one correction.

FIGS. 15A through 15C and 16A through 16C are an example of correcting color saturation and hue in the HSV space. Simply, since it is assumed that the angle with the Cb axis on the plus side of the Cb axis on the CbCr plane (the side indicating the value larger than the value of Cb for monochrome) indicates the hue, and the distance from the achromatic color indicates the color saturation, the correction of the color saturation and the hue may be made in the YCbCr color space. Since the Cb axis and the Cr axis on the CbCr plane are common (generally known as the ITU-R BT 601 standard), they are not illustrated in the attached drawings.

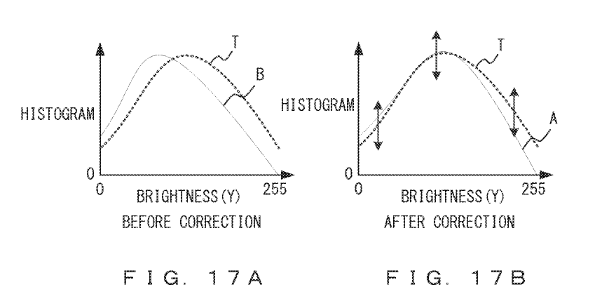

Next, the method of calculating a correction parameter in the above-mentioned correcting process is concretely explained with reference to FIGS. 17A through 22B. The method of calculating the correction parameter is not limited to the method exemplified in FIGS. 17A through 22B, but may be calculated in any optional method.

FIGS. 17A and 17B are example of calculating a correction parameter as a parameter of correcting the brightness distribution B before the correction so that the difference between the brightness distribution A after the correction and the correction target T as a target distribution may be in a specified range in some points (for example, three gray scales of low, medium, and high gray scales).

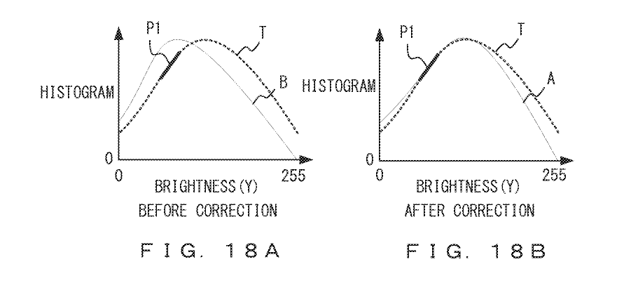

FIGS. 18A and 18B are an example of calculating a correction parameter as a parameter of correcting the brightness distribution B before the correction so that the brightness distribution A after the correction and the correction target T as a target distribution may match at a part P1 of the distribution.

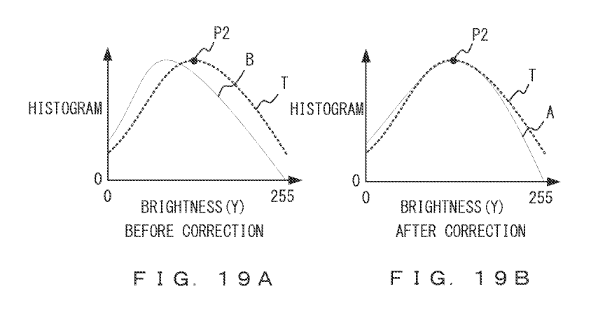

FIGS. 19A and 19B are an example of calculating a correction parameter as a parameter of correcting the brightness distribution B before the correction so that the peak (maximum degree) of the brightness distribution A after the correction and its gray scale may match the peak (maximum degree) of the correction target T as a target distribution and its gray scale.

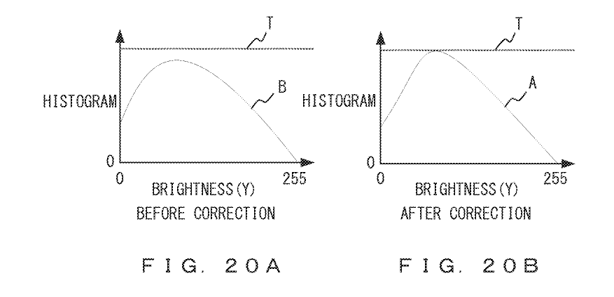

FIGS. 20A and 20B are an example of calculating a correction parameter for correction of the brightness distribution B before the correction so that the peak (maximum degree) of the brightness distribution A after the correction may match the correction target T as the maximum degree of a target brightness.

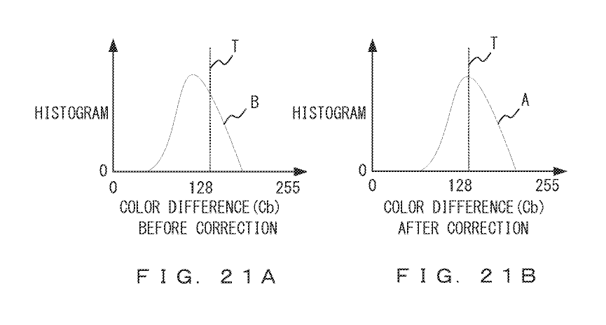

FIGS. 21A and 21B are an example of calculating a correction parameter for correction of the color difference signal distribution B before the correction so that the gray scale indicated by the peak (maximum degree) of the color difference signal distribution A after the correction may match the correction target T as a target gray scale.

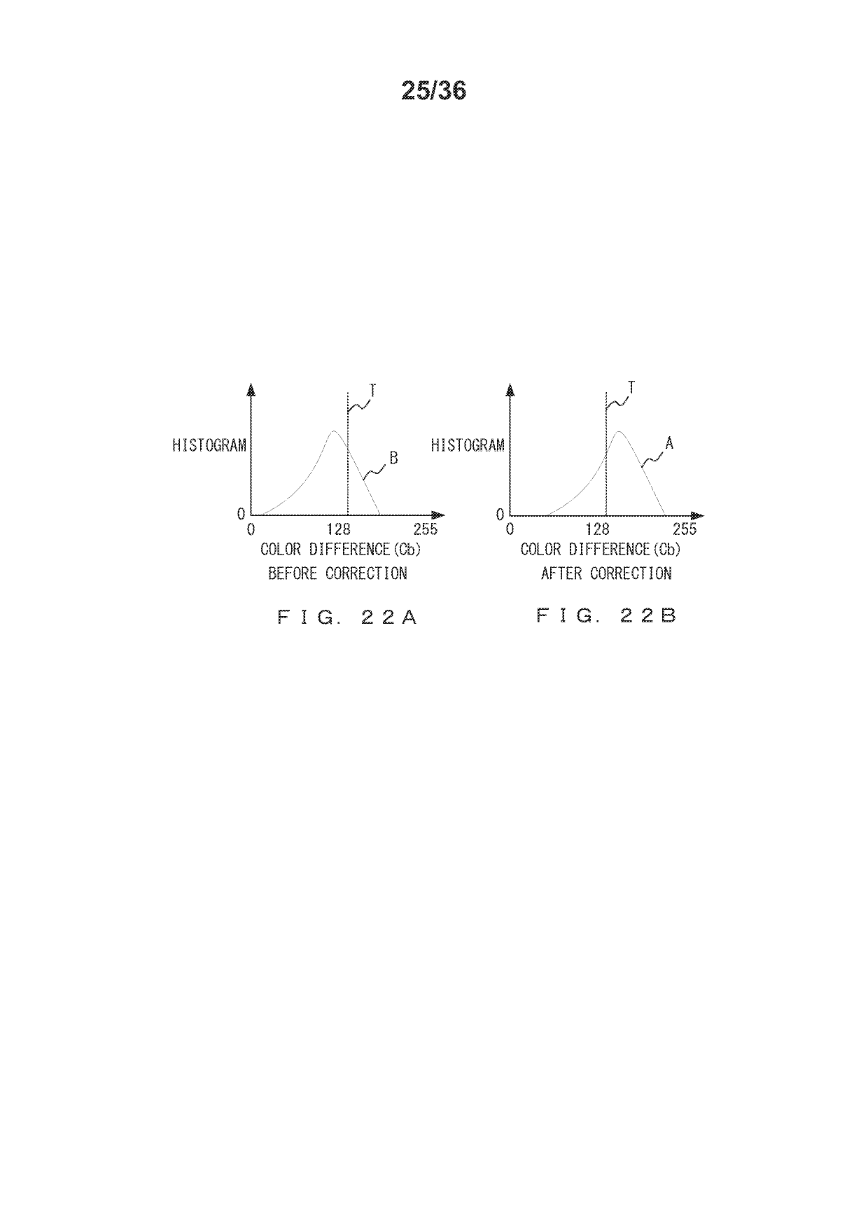

FIGS. 22A and 22B are an example of calculating a correction parameter for correction of the color difference signal distribution B before the correction so that the gray scale indicating the center of the color difference signal distribution A after the correction may match the correction target T as a target gray scale. In this case, the center of the distribution may be determined with the noise taken into account.

With the camera 1 which operates as described above, each of a plurality of frame images configuring a combined image is corrected for the same correction target. Therefore, the feature values of a plurality of frame images which configure a combined image become close and similar to one another, and the differences in feature value among frame images are reduced. As a result, each frame image gives a similar appearance to an observer, thereby generating image data of a combined image having a unified appearance as a whole. In addition, with the camera 1, a special effect is applied to the entire combined image after combining the image data of a plurality of frame images. Thus, the image data of a combined image having a further unified appearance may be generated.

As described above, it is not necessary to correct a frame image for all frame images configuring a combined image. It is also not necessary to calculate the feature value and the correction parameter from all frame images, but they are to be calculated from the frame image to be corrected. On the other hand, a target feature value is calculated not for each frame image, but for each combined image, and the same target feature value is used for all frame images configuring the combined image. It is preferable that the target feature value is calculated from the feature value of a frame image, but a value stored in advance in the flash memory 125 may be used.

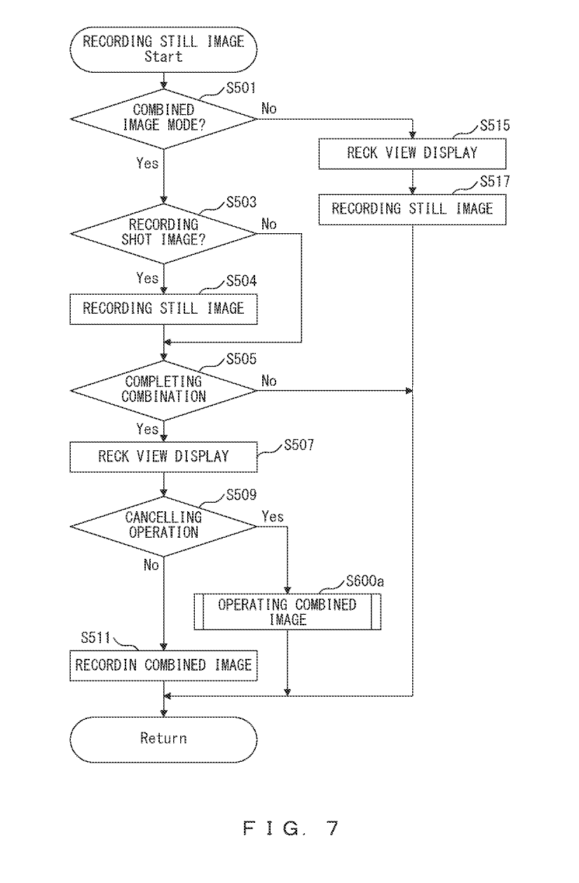

Next, recording a still image after the image processing on the image data acquired in a mechanical shutter shooting illustrated in FIG. 2B is explained further in detail with reference to FIG. 7.

As illustrated in FIG. 7, when the still image recording process is started, the microcomputer 121 first judges whether or not the shooting mode is the combined image mode (step S501). In this step, the judgment is made by the setting of the shooting mode stored in the SDRAM 127.

When the shooting mode is not the combined image mode, the microcomputer 121 controls the display driver 133, and performs the reck view display of one image of the image data shot by a mechanical shutter and processed by the image processing unit 109 (step S515). Then, the microcomputer 121 controls the memory I/F 129 and records the image data of the displayed image in the recording medium 131 (step S517), thereby terminating the still image recording process. The image data may be recorded after compressed by the image compression/decompression unit 117 in the JPEG format, and may be recorded as non-compressed. Furthermore, the RAW image data before image processing by the image processing unit 109 may be recorded.

On the other hand, when the shooting mode is the combined image mode, the microcomputer 121 judges whether or not a setting is to record the image data of the frame image which has been shot (also described as a shot image) to configure a combined image (step S503). When the setting is to record the data, the microcomputer 121 controls the memory I/F 129, and allows the recording medium 131 to record the image data of the frame image processed by the image processing unit 109 (step S504). In this case, in addition to the image data of the frame image after the image processing, the RAW image data and the feature value acquired in the image analysis in step S403 in FIG. 6 may be recorded.

Then, the microcomputer 121 judges whether or not the combination has been completed, that is, whether or not all frame images configuring the combined image have been shot (step S505). If the image which has been acquired in advance and is to be incorporated into the combined image is set, it is judged whether or not all frame images excluding the image acquired in advance have been shot. In this step, the judgment is made based on whether or not the frame images of the number determined depending on the style of the set combined image have been stored in the frame image area of the SDRAM 127. If all frame images have not been shot, then the still image recording process is terminated.

If all frame images have been shot, the microcomputer 121 controls the display driver 133 to perform the reck view display of the combined image acquired by the image processing unit 109 on the display panel 135 (step S507).

Then, the microcomputer 121 monitors the cancelling operation for a specified period (for example, 3 seconds etc.) (step S509) so that a user may be provided with the time to judge whether or not the combined image displayed for the reck view is a requested image.

If the cancelling operation is detected in the specified period, the combined image operating process is performed to cancel the specified image (step S600a), thereby terminating the still image recording process. If no cancelling operation is detected, the microcomputer 121 controls the memory I/F 129 to allow the recording medium 131 to store the image data of the combined image generated by the image processing unit 109 (step S511), thereby terminating the still image recording process.

It is also possible, not to monitor the cancelling operation for a specified period, but to display a screen for inquiry as to whether or not the combined image is recorded (performed) so that the cancelling or the recording may be performed depending on the input of a user.

Next, the combined image operating process is described further in detail with reference to FIGS. 8A and 8B.

As illustrated in FIGS. 8A and 8B, when the combined image operating process is started, the operation which has caused the start of the combined image operating process is specified. Concretely, the microcomputer 121 sequentially judges whether or not the shooting frame changing operation, the cancelling operation, the reconstructing operation, the temporarily storing operation, and the temporary storage reading operation have been performed (step S601, S605, S613, S619, S625)

The judgment whether or not the shooting frame changing operation in step S601 has been performed is made depending on, for example, whether or not the touch input unit 124 has detected the touching operation on the display area in which no image is displayed. When the microcomputer 121 detects the touching operation on the display area in which no image is displayed, it performs the shooting frame changing process, that is, the process of switching to the display area in which a live view image is to be displayed and displaying a live view image in the touched display area (step S603).

The judgment as to whether or not the cancelling operation in step S605 has been performed is made depending on, for example, whether or not the touch input unit 124 has detected the touching operation on the display area in which an image (frame image) based on the RAW image data obtained by shooting a still image using a mechanical shutter is displayed. When the microcomputer 121 detects the touching operation on the display area in which the frame image is displayed, it judges whether or not the touched frame image (display area) is small (step S607).

If it is judged that the frame image is small, the process in step S613 is performed without performing the cancelling process (steps S609 and S611) described later. When the frame image is small, a user easily touches the display area different from an intended display area by, for example, the user erroneously touching a frame image instead of touching a live view image for a shoot instruction. Therefore, to prevent the occurrence of an unintentional cancelling process, the judging process is performed.

It may be judged by the number of display areas or the style of the combined image as to whether or not the frame image is small. That is, it may be set that, for example, if the style corresponding to the layout including a large number of divisions (number of display areas), then it is judged that the frame image is small, and if the styles corresponding to the other layouts are set, then it is judged that the frame image is large.

It may be judged whether or not the frame image is small depending on whether or not the area of the touched display area is smaller than the specified area. In this case, unlike the case in which the judgment is made by the number of display areas or the style of a combined image, the size of the display panel 135 is considered. Therefore, only when the size of the frame image may cause an unintentional cancelling process, the cancelling process may be avoided preferably.

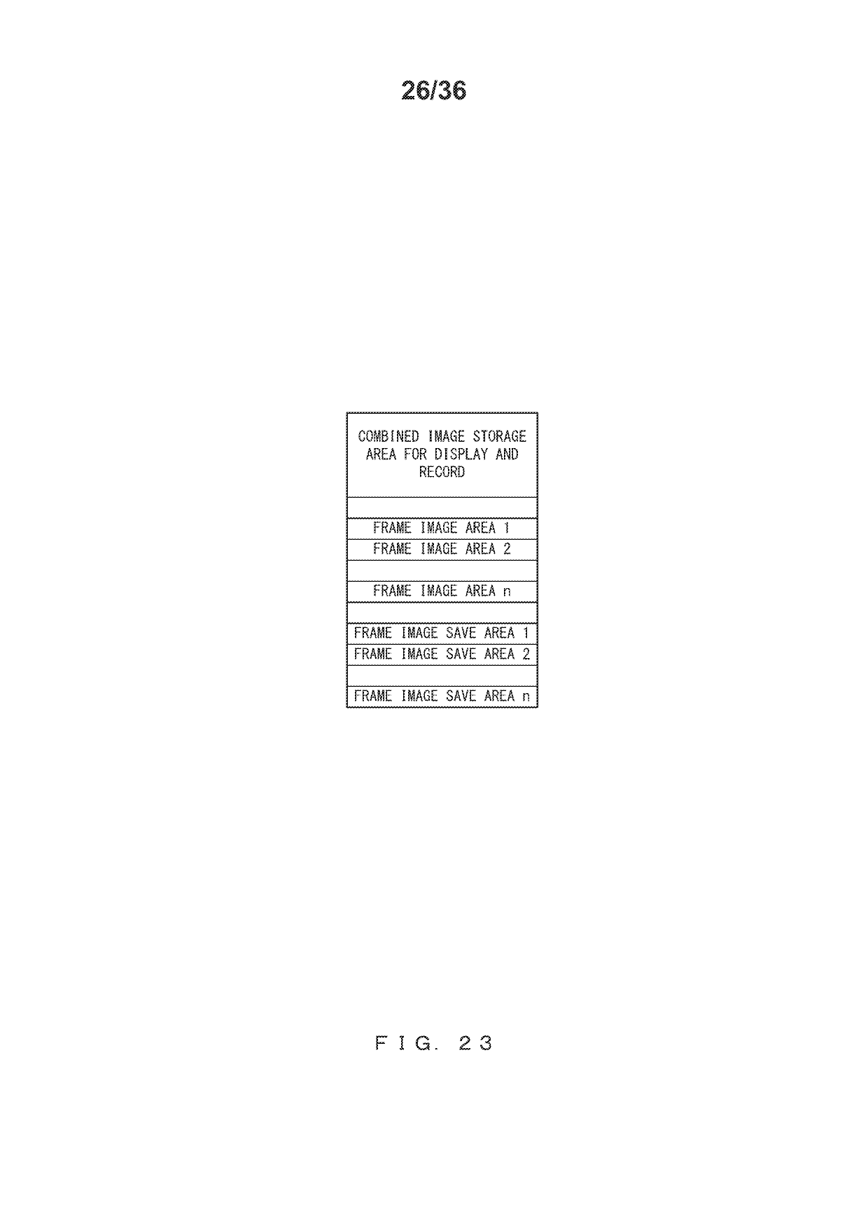

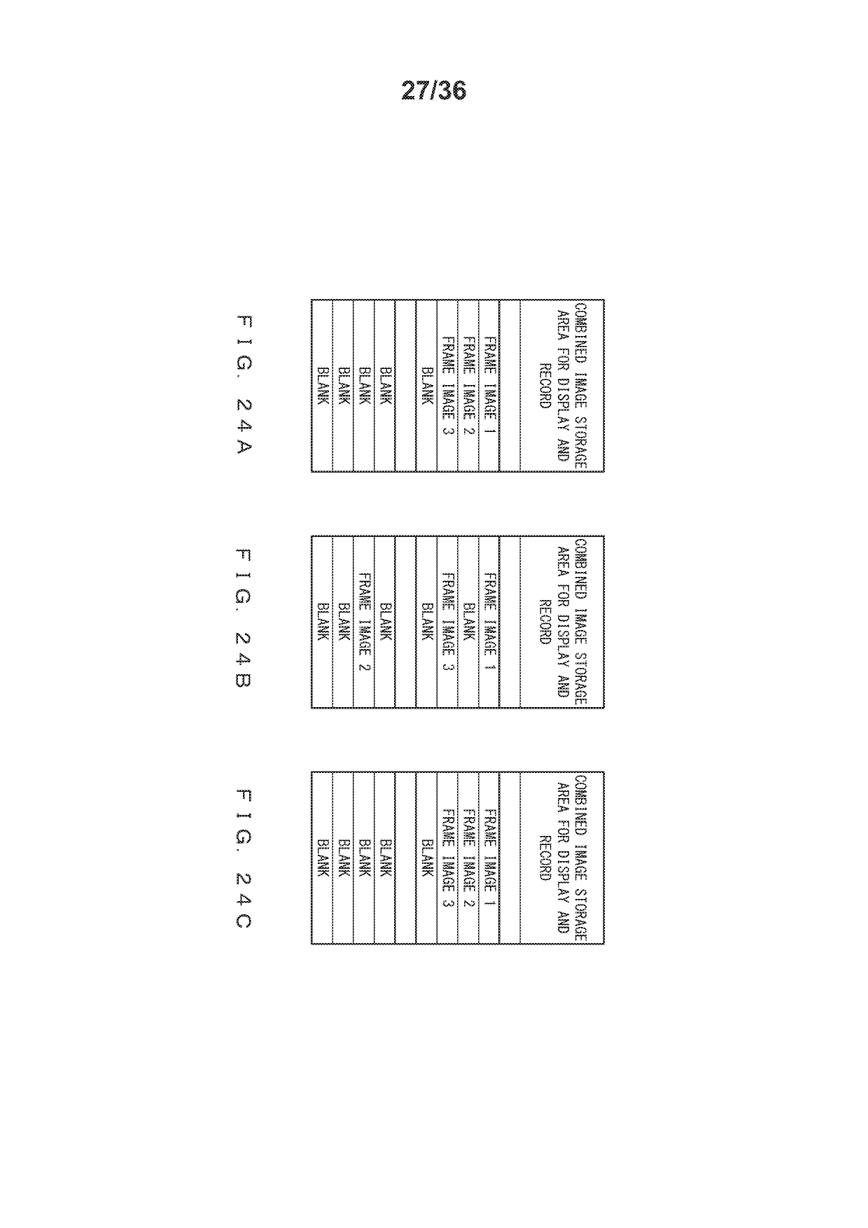

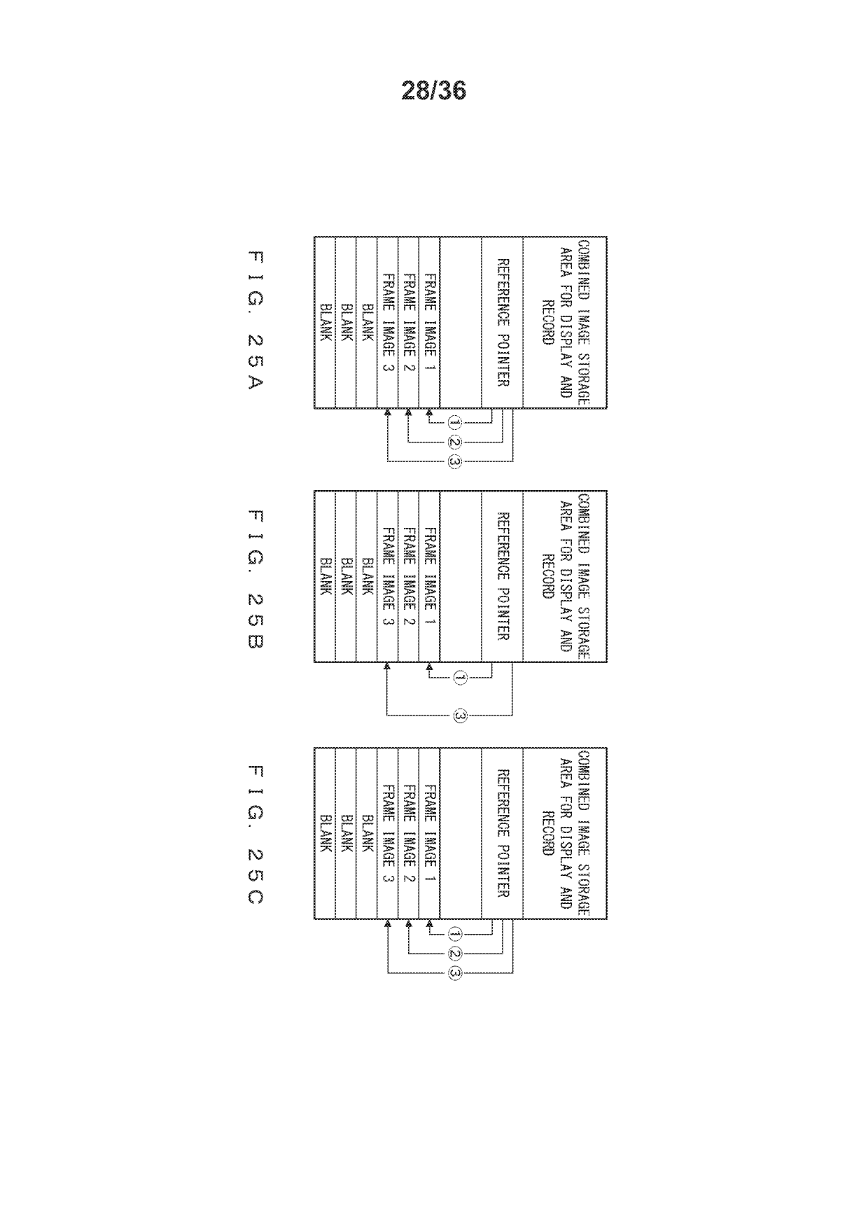

When it is judged that the frame image is large, the microcomputer 121 performs an avoiding process by saving the image data of the frame image displayed in the touched display area (step S609). Concretely, as illustrated in FIG. 23, when a combined image storage area for display and storage, which is configured by a frame image area and a frame image save area, is reserved in the SDRAM 127, for example, as illustrated in FIGS. 24A and 24B, the process of copying the image data of the frame image displayed in the touched display area from the frame image area of the SDRAM 127 to the frame image save area, and deleting the image data stored in and copied from the frame image area is performed. Otherwise, as illustrated in FIGS. 25A and 25B, if the image data of the frame image is managed using a reference pointer, the reference using the reference pointer to the address of the image data may be deleted instead of the deletion of the image data.

Then, the live view display changing process, that is, the process of switching the display area in which a live view image is displayed and changing the image displayed in the touched display area into a live view image is performed (step S611).

The judgment as to whether or not the reconstructing operation in step S613 has been performed is made depending on whether or not the operating unit 123 has detected a specified operation (for example, the double clicking operation on the display area in which a live view image is displayed, the deletion button pressing operation performed by selecting a display area in which a live view image is displayed, etc.). When the reconstructing operation is detected, the microcomputer 121 performs the image reconstructing process of reconstructing image data of the frame image canceled by the cancelling operation (steps S609 and S611) (step S615). Concretely, as illustrated in FIGS. 24B and 24C, for example, the image data of the frame image saved in the save area of the SDRAM 127 is copied to the original frame image area, and the image data of the frame image save area is deleted. Otherwise, as illustrated in FIGS. 25B and 25C, when the image data of the frame image is managed using a reference pointer, the reference to the address of the image data by the reference pointer may be reconstructed.

Then, the live view display changing process, that is, the process of displaying the frame image reconstructed in the display area in which a live view image is displayed, and displaying a live view image in the area in which no frame image is displayed, is performed (step S617).

The judgment as to whether or not the temporary storage operation in step S619 has been performed is made depending on whether or not a specified operation (for example, the pressing operation of the temporary storage button, etc.) has been detected by the operating unit 123. When the temporary storage operation is detected, the microcomputer 121 controls the memory I/F 129 and records the image data of the frame image stored in the combined image storage area of the SDRAM 127 and other data for generation of the image data of the combined image (for example, the data relating to the style of the set combined image, the data indicating the relationship between the image data of the frame image and the display area, etc.) in the recording medium 131 (step S621). The data may be recorded in the flash memory 125 instead of the recording medium 131. Then, the combined image resetting process of deleting the image data stored in the combined image storage area of the SDRAM 127 and updating the display state of the display panel 135 is performed (step S623).

The judgment as to whether or not the temporary storage reading operation in step S625 has been performed is made depending on whether or not the operating unit 123 has detected a specified operation (for example, pressing the temporary storage read button, etc.). When the temporary storage reading operation is detected, the microcomputer 121 judges whether or not the shooting operation is being performed (step S627). It is judged depending on whether or not the image data of the frame image is stored in the combined image storage area of the SDRAM 127.

When it is judged that the shooting operation is being performed, the microcomputer 121 controls the display driver 133, and displays on the display panel 135 the instruction to select whether or not the image data of the frame image stored in the combined image storage area on which the temporary storage processing is performed (step S629). When a user selects temporary storage, the microcomputer 121 controls the memory I/F 129, and record in the recording medium 131 the image data of the frame image stored in the combined image storage area (step S631). The data may be recorded in the flash memory 125 instead of the recording medium 131.

Then, the microcomputer 121 reads from the recording medium 131 the image data of the frame image etc. recorded in step S621, and develops the data in the combined image storage area of the SDRAM 127 (step S633). The image data of the frame image stored in the combined image storage area of the SDRAM 127 is displayed in the display area of the display panel 135, and displays the live view image in the display area in which no frame image is displayed (step S635). Thus, the combined image operating process in FIGS. 8A and 8B is terminated.

With the camera 1 which operates as described above, the display area in which a live view image is displayed may be easily changed by a touching operation. Therefore, a frame image shot in an optional order may be displayed in each of a plurality of display areas. Accordingly, unlike the conventional camera which has a display area determined for the shooting order, a combined image which displays a frame image shot in the intended order in the area intended by a user may be generated. Therefore, the image data of a desired combined image is easily generated. With the camera 1, only by touching the display area in which a frame image is displayed, the frame image is cancelled and changed into a live view image. Therefore, since an undesired frame image may be easily shot again, the image data of a desired combined image may be easily generated.

As described above, with the camera 1 according to the present embodiment, when the operating unit 123 accepts a shoot instruction by touching the display area displayed in a live view image, a frame image is acquired, and the display area in which a live view image is displayed is automatically switched. When the operating unit 123 accepts the cancel instruction by touching the display area in which a frame image is displayed, the frame image is cancelled, and a live view image is displayed for shooting an image again. With the camera 1 according to the present embodiment, the image data of a combined image in which each frame image has a unified appearance as a whole to an observer is generated by correcting a frame image toward the same correction target before the combination. Therefore, with the camera 1 according to the present embodiment, the image data of a desired combined image may be easily generated by a simple operation.

Therefore, a user may maintain a strong motivation to generate a combined image while continuing the shooting operation.

### Embodiment 2

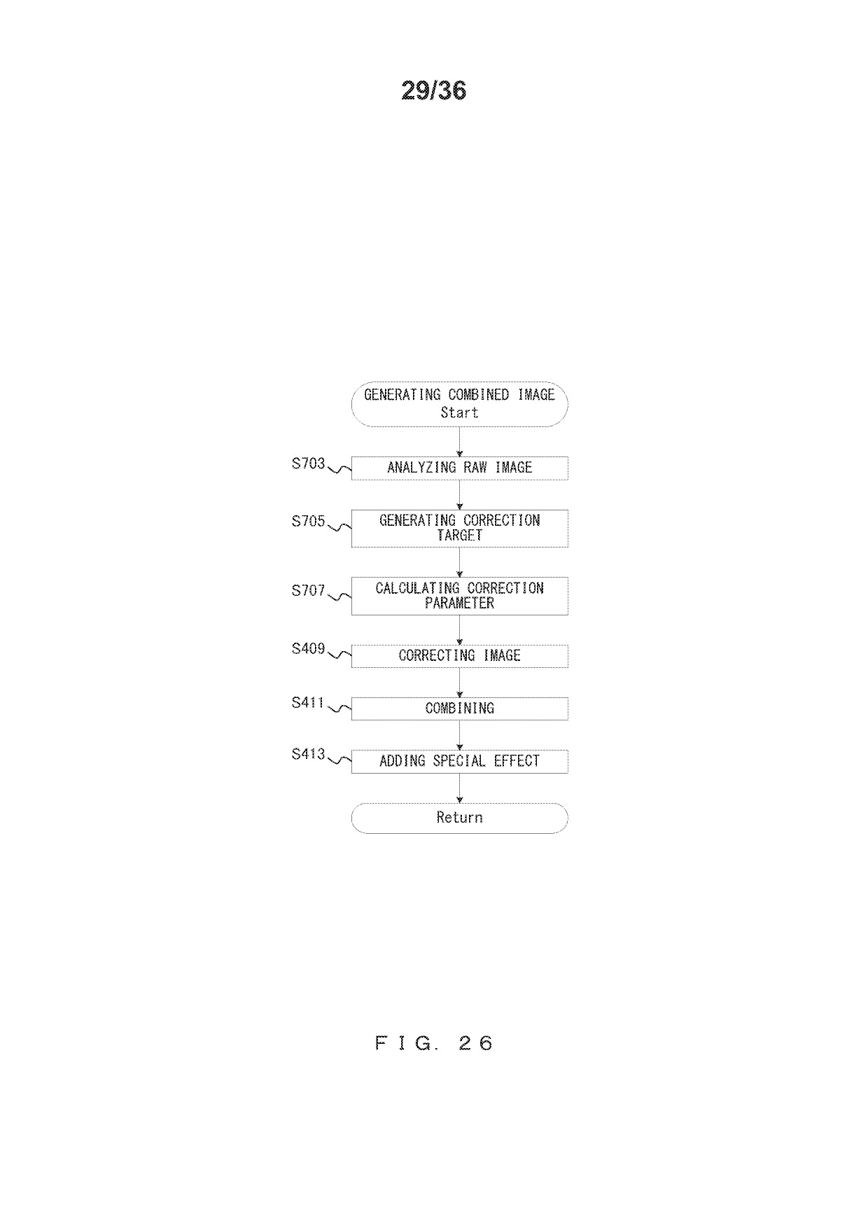

FIG. 26 is a flowchart of the combined image generating process of a camera according to the present embodiment. The camera according to the present embodiment has the same physical configuration as the camera 1 according to the embodiment 1 exemplified in FIG. 1 and performs the same process as the camera 1 except the combined image generating process. The combined image generating process performed by a camera according to the present embodiment is described mainly on the difference from the combined image generating process performed by the camera 1 according to the embodiment 1 with reference to FIG. 26.

The combined image generating process illustrated in FIG. 26 is different from the combined image generating process of the camera 1 according to the embodiment 1 illustrated in FIG. 6 in that the target of an image analysis is the image data (RAW image data) of the frame image before performing the basic image processing. That is, the camera according to the present embodiment calculates a feature value from the RAW image data of the frame image (step S703), calculates a target feature value from the feature value calculated from the RAW image data (step S705), and a correction parameter is calculated from the RAW image data of the frame image and the target feature value (step S707). Therefore, in the still image recording process (step S504) in FIG. 7, it is preferable to make a setting so that RAW image data may be recorded with the image data after the image processing. When the feature value of the frame image acquired in the image analysis in the still image recording process is recorded, the recorded feature value of the frame image may be acquired in step S703. The subsequent process is the same as the process by the camera 1. The frame image on which the basic image processing (and special image processing) was performed is corrected with the correction parameter acquired in step S707 (step S409), and then, the image data of a plurality of frame images including the corrected frame image are combined to acquire a combined image (step S411). Then, finally, a special effect is applied to the entire combined image (step S413).

According to the camera of the present embodiment, the effect of the camera according to the embodiment 1 may be similarly acquired, and the image data of the combined image in which each frame image has a unified appearance and a similar impression to an observer as a whole may be generated.

The camera according to the present embodiment is especially effective when an image processed with a different special effect is incorporated into a combined image. In this case, a request to obtain an combined image having a unified appearance as a whole combined image, and also maintain the difference in special effect added to the image is expected. For example, when an image processed with a special effect (for example, a fantasic focus) to obtain a totally bright image and an image processed with a special effect (for example, a pop art, a toy photo) to obtain an image on which contrast is enhanced are incorporated into a combined image, the feature value is calculated from the image data to which a special effect is applied in the camera 1 according to the embodiment 1, and the corresponding correction parameter is calculated. Therefore, the features of the special effects may be offset. However, with the camera according to the present embodiment, the feature value is calculated from the RAW image data, and the corresponding correction parameter is calculated. Therefore, a combined image having an improved unified appearance as a whole may be acquired while maintaining the difference in added special effect to a certain extent.

### Embodiment 3

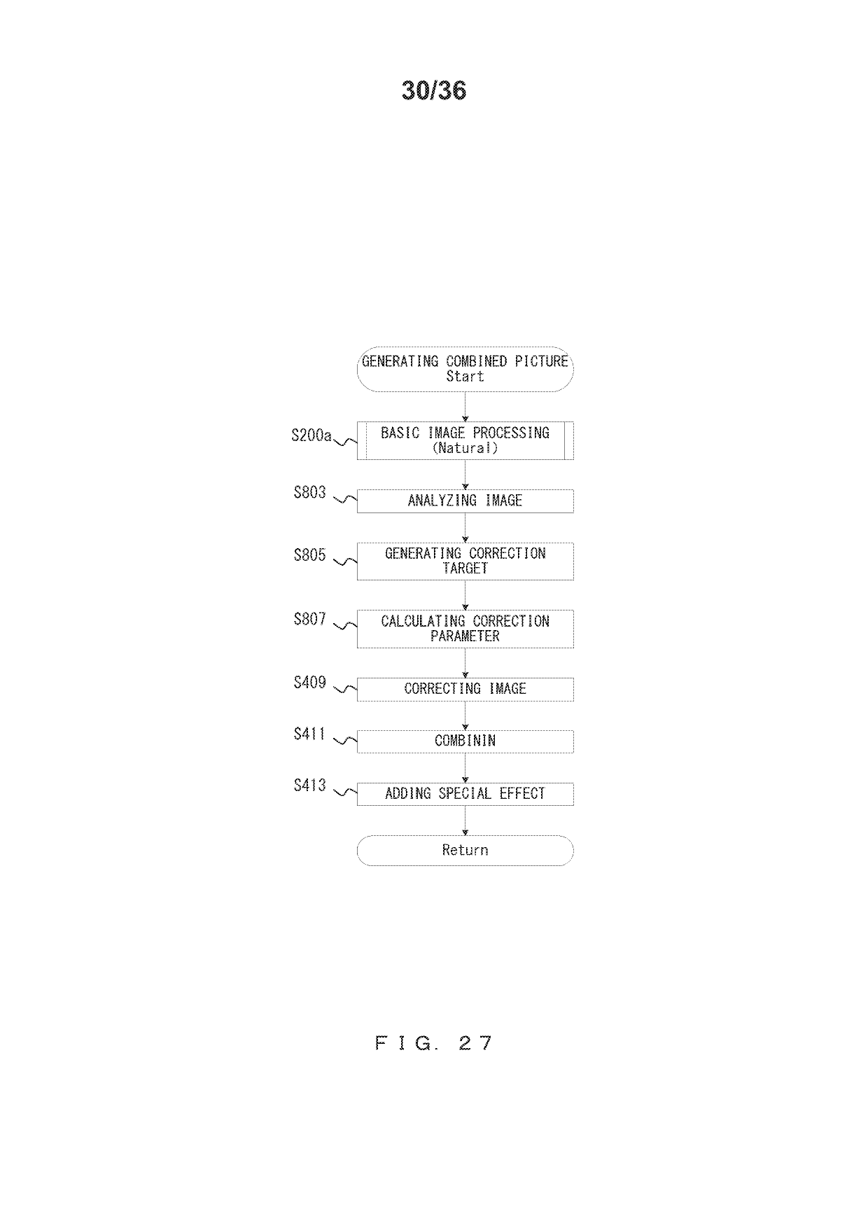

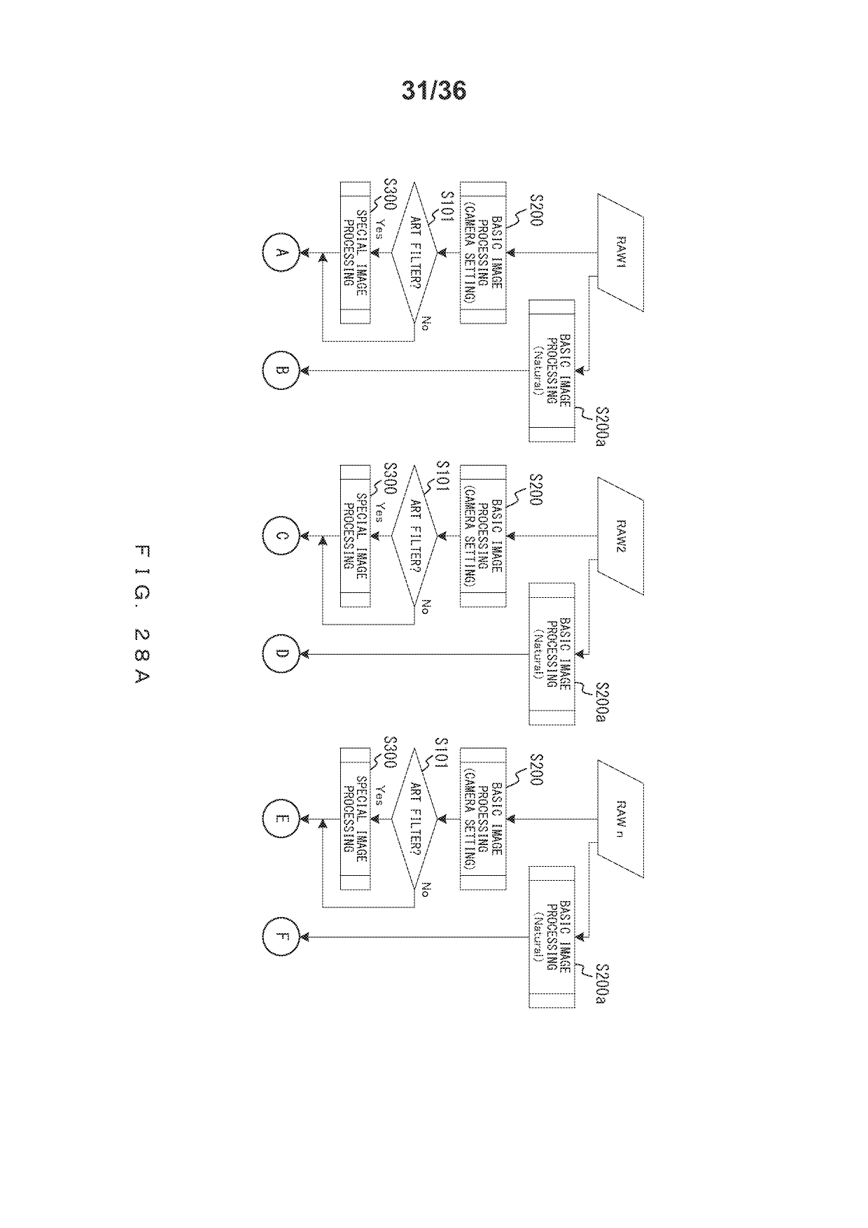

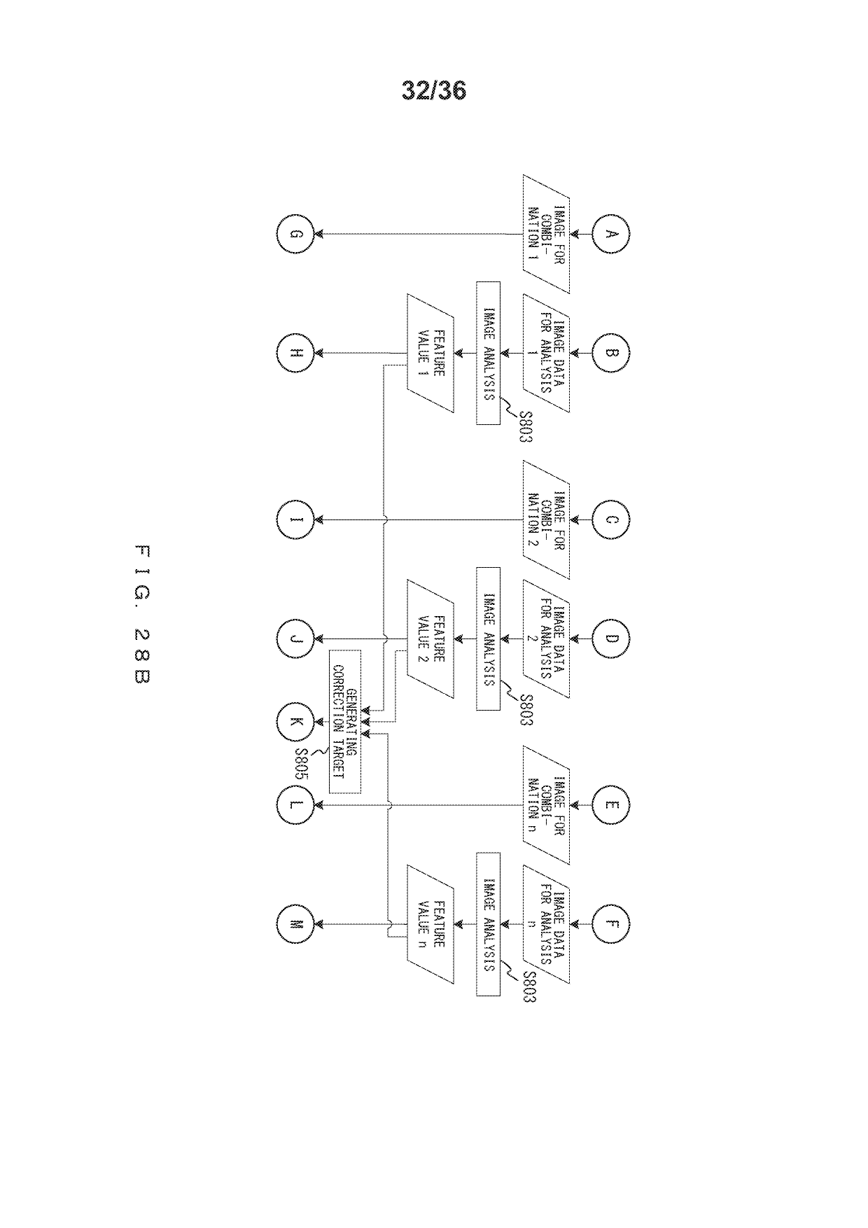

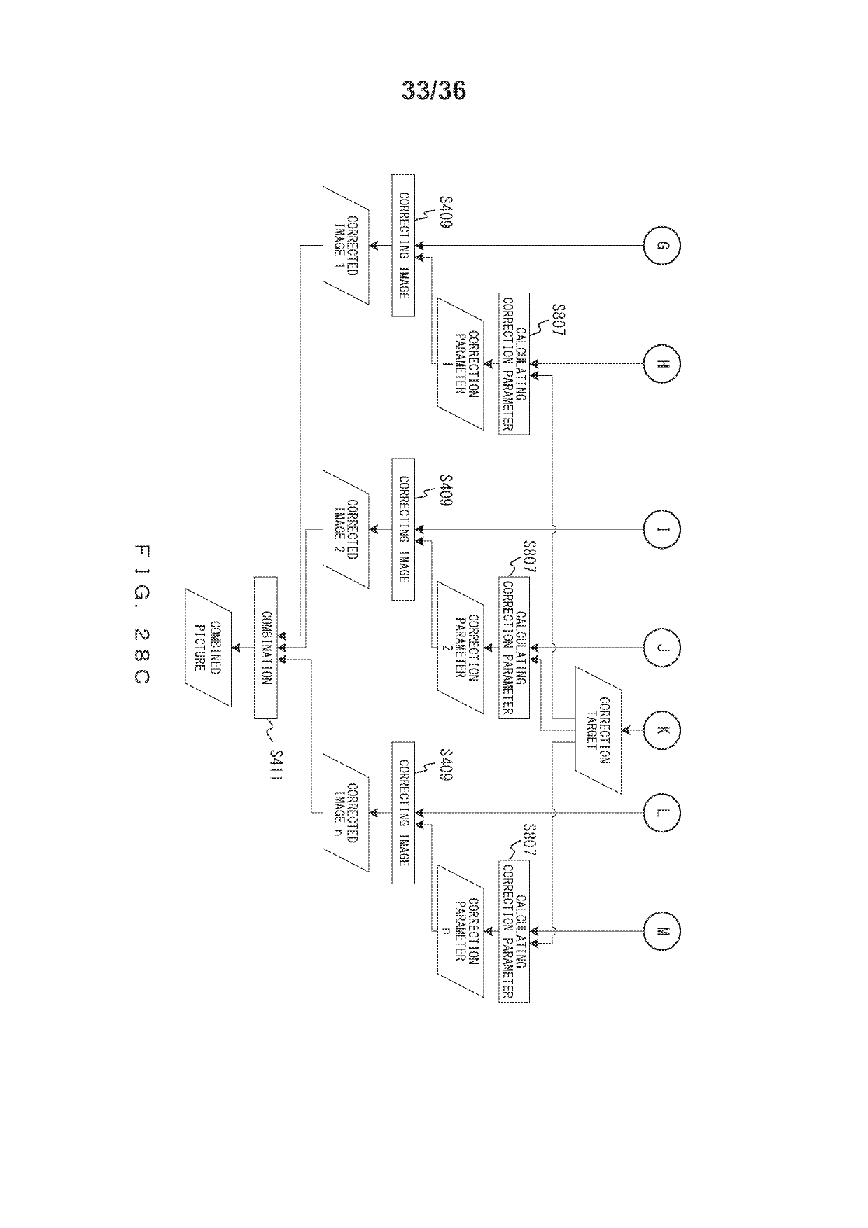

FIG. 27 is a flowchart of the combined image generating process of the camera according to the present embodiment. FIGS. 28A through 28C illustrate the input/output of the data in each process performed to generate combined image data. The camera according to the present embodiment has the same physical configuration as the camera 1 according to the embodiment 1 exemplified in FIG. 1 and performs the same process as the camera 1 except the combined image generating process. The combined image generating process performed by a camera according to the present embodiment is described mainly on the difference from the combined image generating process performed by the camera 1 according to the embodiment 1 with reference to FIGS. 27 through 28C.

The combined image generating process illustrated in FIG. 27 is different from the combined image generating process of the camera 1 according to the embodiment 1 illustrated in FIG. 6 in that the basic image processing is performed on the RAW image data of the frame image before analyzing an image, and the image data on which the basic image processing has been performed is defined as a target of the image analysis. Unlike the basic image processing in FIG. 3, the basic image processing performed before the image analysis operates by a specified setting (for example, a natural setting in the present embodiment) determined in advance without a setting of a finishing of an image as one of the settings of a camera. That is, the camera performs the basic image processing with the natural setting on the RAW image data of a frame image (step S200a), calculates the feature value from the image data (hereafter referred to as natural image data) that is the output of the process (step S803), calculates the target feature value from the feature value calculated from the natural image data (step S805), and calculates a correction parameter from the natural image data of the frame image and the target feature value (step S807). Therefore, in the still image recording process (step S504) in FIG. 7, it is preferable to set in advance so that the RAW image data may be stored with the image data after the image processing. The subsequent processes are similar to those of the camera 1. The frame image on which the basic image processing (and the special image processing) are performed based on the setting of the finish of the camera illustrated in FIG. 3 is corrected with the correction parameter obtained in step S807 (step S409), and then the image data of a plurality of frame images including the corrected frame image are combined to obtain a combined image (step S411). Then, finally, a special effect is applied to the entire combined image (step S413). Therefore, as illustrated in FIGS. 28A through 28C, in the camera according to the present embodiment, the RAW image data of the frame image is not only used as an input of a series of processes (steps S200, S300) for generating the image data of the frame image to be corrected, but also as an input of a series of processes (steps S200a, S803, S805, S807) for calculation of the correction parameter.

Also with the camera according to the present embodiment, similar effects to those of the camera according to the embodiment 1 may be obtained, and the image data of the combined image in which each frame image has a unified appearance and a similar impression to an observer as a whole may be generated. Furthermore, since the camera according to the present embodiment calculates the correction parameter from the image data before the special image processing as with the camera according to the embodiment 2, a combined image having an improved unified appearance as a whole may be acquired while maintaining the difference in added special effect to a certain extent.

The camera according to the present embodiment may generate a combined image having a more unified appearance as compared with the camera according to the embodiment 2 because the RAW image data may be quite different in brightness from the image data after the basic image processing by the brightness changing process by a gamma correction performed in the basic image processing, and the unified appearance is not satisfactorily improved between the frame images in the correction with a correction parameter obtained in the state quite different in brightness. Furthermore, in the appearance of color, the white balance correcting process performed in the basic image processing largely affects the unified appearance.

### Embodiment 4

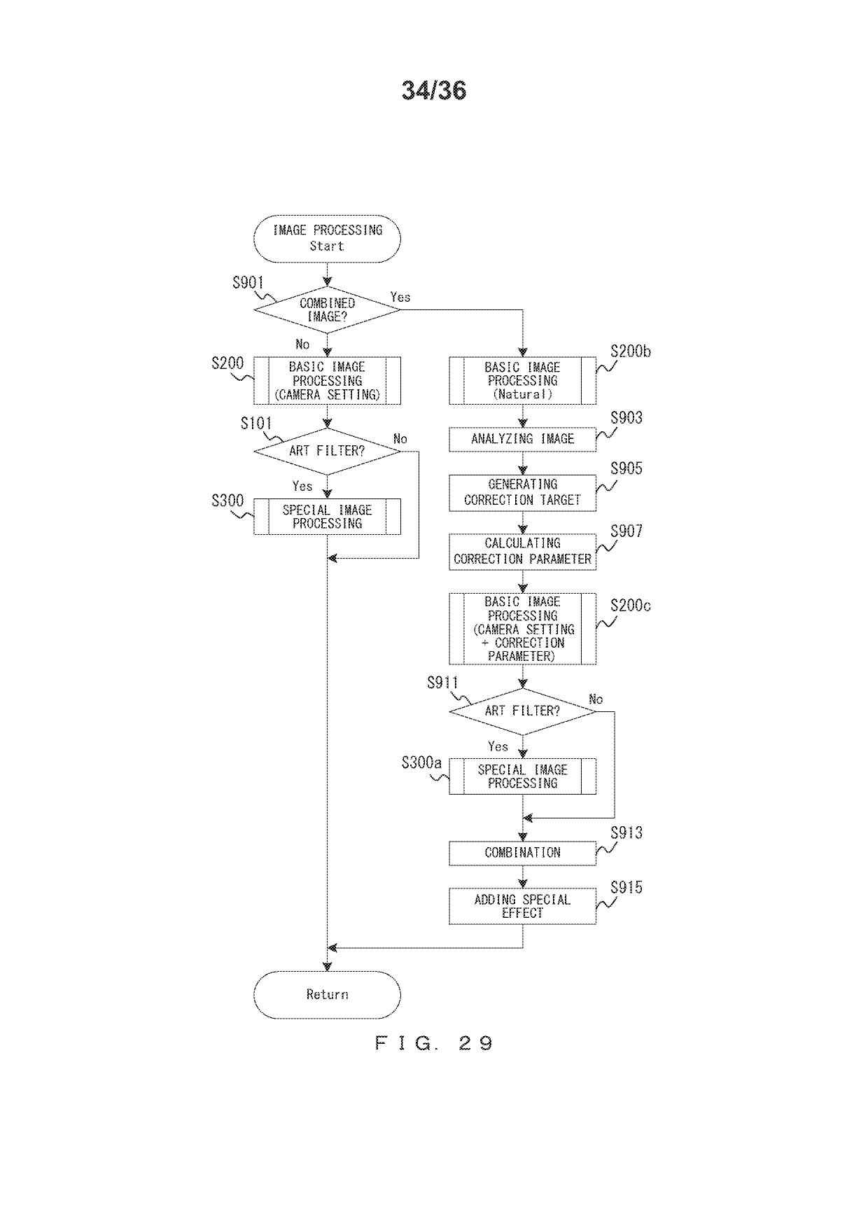

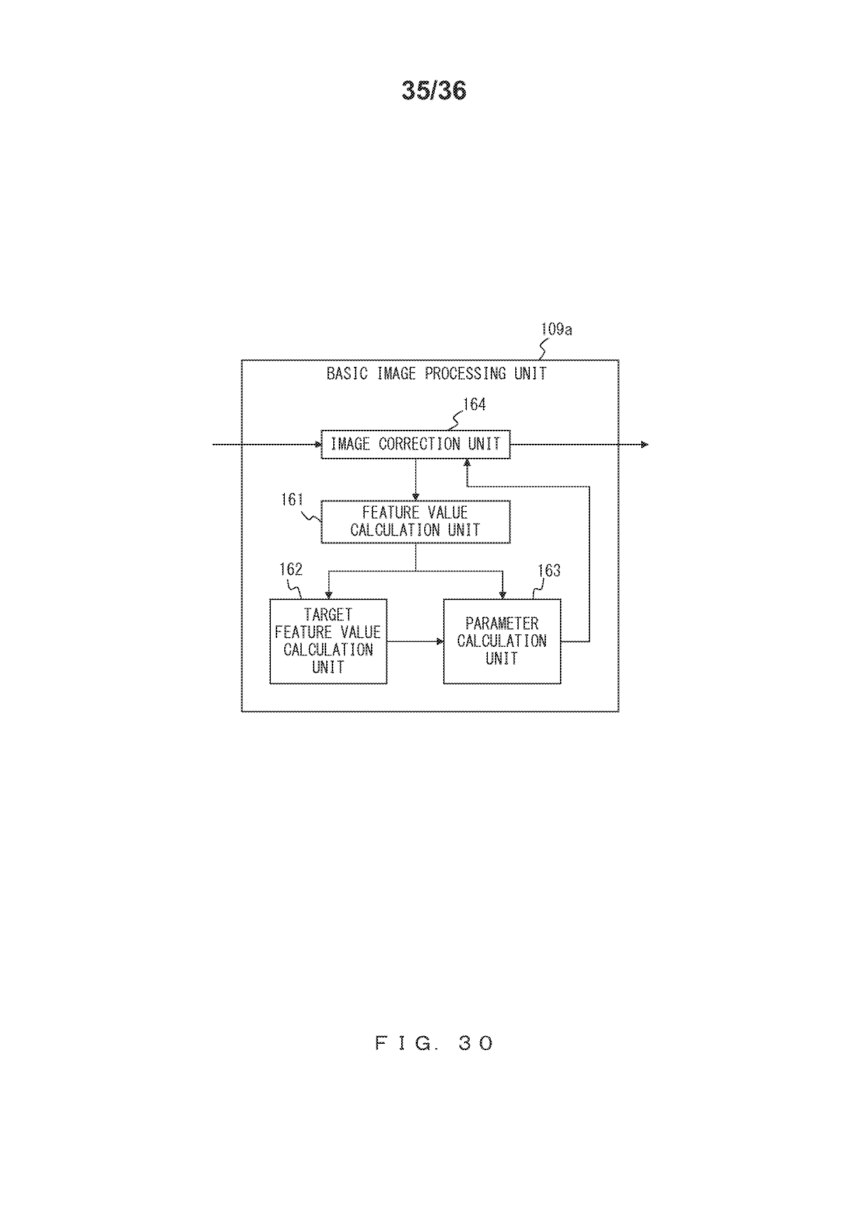

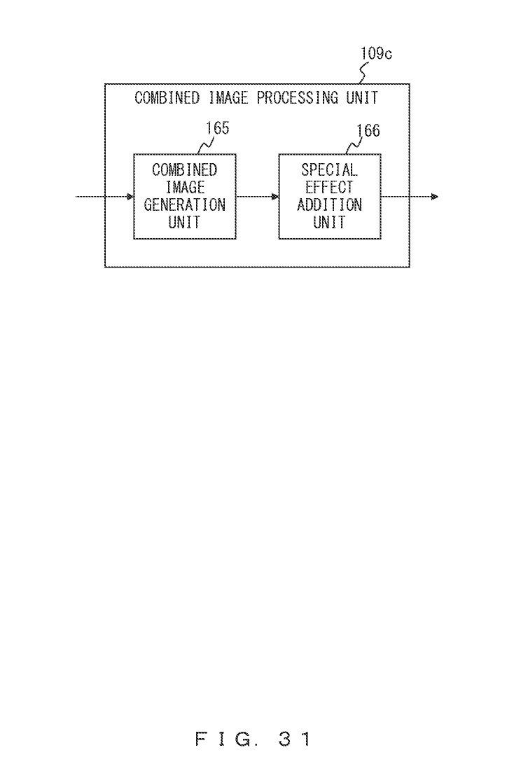

FIG. 29 is a flowchart of the image processing of the camera according to the present embodiment. FIG. 30 is a block diagram of the function of the basic image processing unit of the camera according to the present embodiment. FIG. 31 is a block diagram of the function of the combined image processing unit of the camera according to the present embodiment. The camera according to the present embodiment has the same physical configuration as the camera 1 according to the embodiment 1, and is configured to perform the same process as the camera 1 excluding the image processing. The functions of the basic image processing unit 109a and the combined image processing unit 109c are different from the camera 1 according to the embodiment 1 as illustrated in FIGS. 30 and 31. The image processing performed by the camera according to the present embodiment is described below with reference to FIGS. 29 through 31 by mainly describing the difference from the image processing performed by the camera 1 according to the embodiment 1.

The camera 1 according to the embodiment 1 calculates the correction parameter in the combined image processing performed after the basic image processing and the special image processing and corrects the frame image while the camera according to the present embodiment calculates the correction parameter before the process (step S200c) corresponding to the conventional basic image processing, and uses the correction parameter as a parameter of the basic image processing to correct the frame image, which is quite different from the camera 1 according to the embodiment 1.

The image processing performed when the shooting mode is not the combined image mode is substantially the same as the camera 1 according to the embodiment 1.

The image processing performed in the combined image mode is concretely explained. First, when the combined image mode is confirmed (step S901), the image correction unit 164 of the basic image processing unit 109a performs the basic image processing on the RAW image data with a specified setting (for example, the natural setting in the present embodiment) determined in advance without a setting of the camera (setting of a finish of an image) (step S200b). Then, a feature value calculation unit 161 analyzes the output data and calculates the feature value (step S903), and a target feature value calculation unit 162 calculates the target feature value as a correction target from the calculated feature value (step S905). Furthermore, a parameter calculation unit 163 calculates the correction parameter for correction performed so that feature values of the frame images may be similar to each other from the feature value calculated by in step S903 and the target feature value calculated in step S905 (step S907). Concretely, for example, the feature value and the target feature value are brightness distributions, and the correction parameter is a gamma conversion table. As a correction parameter, a WB gain (R gain, B gain) may be calculated. Afterwards, the image correction unit 164 performs the basic image processing on the RAW image data of the frame image according to the camera setting and the correction parameter obtained in step S907 (step S200c). When an art filter is set, the special image processing unit 109b performs the special image processing (steps S911, S300a). When these processing terminates, a combined image generation unit 165 of the combined image processing unit 109c combines a plurality of frame images as outputs on the background image (step S913), and finally a special effect addition unit 166 adds a special effect to the combined image (step S915), thereby terminating the image processing.

In the camera according to the present embodiment, the basic image processing unit 109a manages some (feature value calculation unit 161, target feature value calculation unit 162, parameter calculation unit 163, image correction unit 164) of the functions managed by the combined image processing unit 109c of the camera according to the embodiment 1 to use the correction parameter as the parameter of the basic image processing. Since the correction parameter is to be used as a parameter of the basic image processing, the target of the image analysis for obtaining the correction parameter may be RAW image data. In this case, step S200b may be omitted.

With the camera according to the present embodiment, an effect similar to that according to the camera of the embodiment 1 may be obtained, and the image data of the combined image in which each frame image has a unified appearance and a similar impression to an observer as a whole may be generated. The camera according to the present embodiment calculates the correction parameter from the image data before the special image processing as with the camera according to the embodiments 2 and 3. Therefore, although an image which is acquired in advance and to which a special effect different from the setting of the camera has already been added is incorporated into a combined image, a combined image having an improved unified appearance as a whole may be acquired while maintaining the difference in added special effect to a certain extent.

With the camera according to the present embodiment, the correction parameter is used as a parameter of the basic image processing for processing the RAW image data. That is, with the camera according to the present embodiment, the target of the correction is RAW image data, which is quite different from the cameras according to other embodiments.

Generally, in the image processing, the process of resizing an image by reducing the number of gray scales during the process is performed to suppress the operation time and circuit size. For example, in the case of a camera according to the present embodiment, to reduce the circuit size of the combined image process used in the combined image mode, the configuration of resizing the image after the special image processing is estimated. Since there occurs a difference in correction accuracy between the case in which image data before resizing is corrected and the case in which image data after the resizing process is corrected, there may be a difference unified appearance of combined image. Therefore, to obtain a better unified appearance, it is preferable that larger RAW image data is target to be corrected. Therefore, according to the camera according to the present embodiment, a combined image having a more unified appearance may be generated than the cameras according to other embodiments for correcting the image after the special image processing. On the other hand, when shortening the processing time is more seriously considered than the unified appearance of an image, cameras according to other embodiments are more preferable.

As described above, a digital camera is exemplified and described as an image processing device, but the above-mentioned technique is not limited to the equipment dedicated to a camera, but may be applied to a mobile telephone with a camera (smart phone), tablet equipment, other mobile device, etc. It is also applied to an image processing device having no shooting function, for example, a personal computer etc. The above-mentioned embodiments are concrete examples of the present invention for easy understanding of the invention, but the present invention is not limited to the embodiments. The image shooting device according to the present invention may be variously transformed and modified within the gist of the concept of the present invention regulated within the scope of the claims of the present invention. If similar effects are obtained, the order of the process is not limited to the processes above, but steps of the process of the flowchart may be exchanged. The example of transforming on the YCbCr axis is explained, but the process holds true in other color spaces. For example, in the present embodiment, the HSV and YCbCr color spaces are used, but other YPbPr color space (regulated as the ITU-R BT709), average color space (L*a*b*) etc. may be used. An application on the axis with any coordinate axis defined in the same color space may also be used.

What is claimed is:

1. An image processing device which lays out a plurality of images to generate image data of a combined image, comprising:
a feature value calculation unit which calculates from an image configuring the combined image a feature value indicating a feature of the image;
an image correction unit which corrects the image whose feature value is calculated so that the feature value calculated by the feature value calculation unit approaches a target feature value; and
a combined image generation unit which generates image data of the combined image by combining image data of the plurality of images including the image corrected by the image correction unit.

2. The device according to claim 1, further comprising
a target feature value calculation unit which calculates the target feature value from the feature value calculated by the feature value calculation unit.

3. The device according to claim 1, further comprising
a parameter calculation unit which calculates a correction parameter from the feature value calculated by the feature value calculation unit and the target feature value, wherein
the image correction unit corrects an image whose feature value is calculated according to the correction parameter calculated by the parameter calculation unit.

4. The device according to claim 1, wherein
the feature value includes at least one of a brightness distribution, a color difference signal distribution, a color saturation distribution, a hue distribution of an image configuring the combined image.

5. The device according to claim 1, further comprising
a special effect addition unit which adds special effect to image data of the combined image generated by the combined image generation unit.

6. The device according to claim 1, further comprising
an image pickup unit which acquires a shot image by shooting a subject, wherein
at least one of the plurality of images configuring the combined image is a shot image acquired by the image pickup unit.

7. The device according to claim 6, further comprising
a display unit which displays the combined image.

8. The device according to claim 7, wherein
the display unit performs live view display for a shot image acquired repeatedly by the image pickup unit.

9. The device according to claim 6, further comprising
a recording unit which records an image, wherein
the recording unit records a shot image acquired repeatedly by the image pickup unit as moving pictures.

10. A method for processing an image of an image processing device which lays out a plurality of images to generate image data of a combined image, comprising:
calculating from an image configuring the combined image a feature value indicating a feature of the image;
correcting the image whose feature value is calculated so that the calculated feature value approaches a target feature value; and
generating image data of the combined image by combining image data of the plurality of images including the corrected image.

11. A non-transitory storage medium which stores an image processing program for directing a computer to use a method for processing an image by laying out a plurality of images and generating image data of a combined image, and to perform processes, comprising:
calculating from an image configuring the combined image a feature value indicating a feature of the image;
correcting the image whose feature value is calculated so that the calculated feature value approaches a target feature value; and
generating image data of the combined image by combining image data of the plurality of images including the corrected image.
